(19) United States
(12) Patent Application Publication
(10) Pub. No.: US 2026/0293924 A1
(43) Pub. Date: Oct. 1, 2026

(54) DAIRY FOOD GEL PRODUCTION

(71) Applicant: FONTERRA CO-OPERATIVE GROUP LIMITED, Auckland (NZ)

(72) Inventors: Osama Mohammad ABUSIDOU, Palmerston North (NZ); Lilian de Barros FERREIRA, Palmerston North (NZ); John Andrew RAMSAY, Palmerston North (NZ); Vijaya Bhaskar GANUGAPATI, Palmerston North (NZ); Simon Craig DAVEY, Palmerston North (NZ); Rachel Maree TAYLOR, Palmerston North (NZ); Raul IANCHICI, Palmerston North (NZ); Ashleigh Marie PHILPOTT, Cambridge (NZ)

(21) Appl. No.: 19/479,653

(22) PCT Filed: Apr. 30, 2024
(86) PCT No.: PCT/NZ2024/050045

§ 371 Date: Oct. 28, 2025

(30) Foreign Application Priority Data
May 1, 2023 (AU) 2023901271

(51) Int. Cl. A23C 19/028; A23C 19/05; A23C 19/072; A23C 19/076; A23J 1/20

(52) U.S. Cl. CPC A23C 19/0285; A23C 19/05; A23C 19/072; A23C 19/0765; A23J 1/20

(57) ABSTRACT

The present disclosure relates to on-demand dairy food gel production and processes for preparing on-demand dairy food gels. The present disclosure also relates to processes for preparing milk protein concentrate ingredients and dairy food gel ingredients thereof, which can be used for on-demand dairy food gel production, and systems and methods thereof.

### FIELD

The present disclosure relates to on-demand dairy food gel production and processes for preparing on-demand dairy food gels. The present disclosure also relates to processes for preparing milk protein concentrate ingredients and dairy food gel ingredients thereof, which can be used for on-demand dairy food gel production, and systems and methods thereof.

In particular, the present disclosure provides a dairy food gel ingredient and dairy food gel production that is versatile, customisable and capable of various rapid on-demand or on-site applications. For example, distributed manufacturing of various cheese products of different textures can be provided from an ambient stable dairy food gel ingredient, such as a milk protein concentrate (MPC) or dairy food gel ingredient comprising an MPC. The present disclosure is useful for enabling on-demand personalised preparation of customisable dairy food gel products, which in some examples may be prepared using standard household or industrial appliances. The ingredients and processes of the present disclosure can provide dairy food gel products customisable in terms of texture, flavour, and nutrition, and which together constitute a variety of cheese-like products, such as cheddar-style, mozzarella-style, and cream-cheese-style. The present disclosure also provides for personalisation of macronutrients (e.g. fat, protein and carbohydrates) and additives (e.g. flavourings, vitamins and probiotics).

### BACKGROUND

Traditional cheese can be categorised as a food gel consisting of a hydrated protein matrix containing dispersed fat particles. An extensive amount of research and commercial development over many years has been focused on providing processed dairy ingredients for large scale manufacture of various dairy gel products. However, on-demand personalized food and nutrition is becoming increasingly important. Dairy food gels such as cheeses can provide an excellent source of nutrition, although these products take time to make, need to be transported in refrigerated vessels, and have limited shelf-life. Current products also have a predetermined format, composition, nutritional properties, flavour, and texture. To obtain variation in texture and organoleptic properties of cheese types, cheese making has required adjusting compositions using a large combination and range of ingredients in addition to controlling various complex processing parameters during production.

There is a need for providing a more versatile dairy ingredient capable of use by itself, or together with a smaller selection of additional ingredients, and using less complex processing parameters for obtaining a variety of diary food gels such as cheese types having variation in texture and organoleptic properties. There is also a need for providing on-demand personalised foods or food ingredients that can be produced in tailored quantities on-site. For example, a dairy food gel produced from a processed dairy ingredient, which is versatile, customisable in texture, flavour and nutrition, and capable of rapid on-demand applications, such as distributed manufacturing or on-site production.

It will be understood that any prior art publications referred to herein do not constitute an admission that any of these documents form part of the common general knowledge in the art, in Australia or in any other country.

### SUMMARY

The present inventors have undertaken significant research into identifying and developing a dairy food gel ingredient and dairy food gel production that is versatile, customisable and capable of various rapid on-demand or on-site applications. For example, distributed manufacturing of various cheese products of different textures can be provided from an ambient stable dairy food gel ingredient, such as a milk protein concentrate (MPC) or dairy food gel ingredient comprising an MPC.

In one aspect, there is provided a process for preparing from one or more ingredients a plurality of dairy food gel products having a range of predetermined organoleptic properties, wherein at least one ingredient is a milk protein concentrate (MPC) or dairy food gel ingredient comprising an MPC, wherein the process comprises the steps of:
selecting process conditions for at least one of the plurality of dairy food gel products having predetermined organoleptic properties, wherein the process conditions comprise or consist of predetermined parameters selected from liquid content, process temperature, and process duration;
processing the ingredients according to the selected process conditions; and
obtaining at least one of the plurality of dairy food products having predetermined organoleptic properties based on the selected process conditions.

In another aspect, there is provided a process of modulating texture of a mixture of one or more ingredients, wherein at least one ingredient is a milk protein concentrate (MPC) or dairy food gel ingredient comprising an MPC, wherein the method comprises the steps of:
selecting process conditions comprising or consisting of predetermined parameters selected from liquid content, process temperature, and process duration;
processing the ingredients according to the selected process conditions to form a dairy food gel product having predetermined texture based on the selected process conditions; and
obtaining the dairy food gel product.

In some embodiments, the process conditions consist of predetermined parameters selected from liquid content, process temperature, process duration, and optionally process mixing. In some embodiments, the process conditions consist of predetermined parameters selected from liquid content, process temperature, and process duration.

In some embodiments, at least one or at least two ingredients are selected from an MPC or dairy food gel ingredient comprising an MPC. In some embodiments, the MPC is selected from any one or more of a fermented MPC (fMPC), calcium reduced MPC (cMPC), and a fermented calcium reduced MPC (fcMPC).

In some examples, the MPC is prepared comprising the steps of:
subjecting concentrated milk, reconstituted dry milk concentrate or an aqueous solution comprising an MPC to a divalent ion reduction or exchange step to obtain a divalent ion reduced retentate (e.g. cMPC) having a calcium content, monovalent cation to divalent cation ratio, or cationic balance, according to any embodiments or examples thereof as described herein;
subjecting the retentate to fermentation to produce a fermentate according to any embodiments or examples thereof as described herein;
concentrating the fermentate to produce an MPC ingredient (e.g. fcMPC); and
recovering the MPC ingredient.

In some embodiments, the method further comprises subjecting the fermentate to an enzymatic modification. In some embodiments, the enzymatic modification is κ-casein cleavage, for example renetting.

In another aspect, there is provided a dairy food gel product prepared according to any aspects, embodiments or examples of the process as herein described.

In another aspect, there is provided a milk protein concentrate (MPC) ingredient, wherein the MPC comprises:
a fat content of between 0 to about 60% w/w;
a calcium content of between about 20 to about 400 mmol/kg; and
a cationic balance of between about 1 to about 100.

In some embodiments, the fat content of the MPC is between about 40 to about 60% w/w. In some embodiments, the calcium content of the MPC is between about 20 to about 100 mmol/kg. In some embodiments, the cationic balance of the MPC is between about 15 to 50.

In some embodiments, the MPC has a monovalent to divalent cation ratio of between about 5 to 25. In some embodiments, the MPC has a milk protein content of between about 20 to 95% w/w. In some embodiments, the MPC ingredient is a fermented MPC ingredient.

In another aspect, there is provided a dairy food gel ingredient comprising the MPC ingredient and one or more additive ingredients according to any aspects, embodiments, or examples thereof as described herein.

In some embodiments, the one or more additive ingredients comprise any one or more ingredients selected from a fat additive ingredient, a mineral salt additive ingredient, and a food acid additive ingredient. In some embodiments, the one or more additive ingredients comprise any one or more ingredients selected from flavourings, colourants, sweeteners, emulsifiers, stabilisers, and thickeners. In some embodiments, the one or more additive ingredients comprise any one or more ingredients selected from proteins, prebiotics, probiotics, and postbiotics. In some embodiments, the dairy food gel ingredient, the MPC, one or more additives, may be in the form of a powder or dry mixture.

It will be appreciated that other aspects, embodiments and examples of the products and ingredients are described herein, along with preparation, methods and systems for production thereof.

### BRIEF DESCRIPTION OF THE DRAWINGS

Particular embodiments of the present disclosure are further described and illustrated as follows, by way of example only, with reference to the accompanying drawings in which:

FIG. 1 is a flow diagram illustrating a process of the present disclosure, of producing a modified MPC ingredient, and subsequently production of a dairy food gel product; and

FIG. 2 is a system diagram illustrating food processing system that can be used in the process of the present disclosure.

### DETAILED DESCRIPTION

The present disclosure describes the following various non-limiting embodiments, which relate to substantial research undertaken into identifying and developing a dairy food gel ingredient and dairy food gel production that is versatile, customisable and capable of various rapid on-demand applications. For example, distributed manufacturing of various cheese products of different textures can be provided from an ambient stable dairy food gel ingredient, such as a fermented and calcium depleted milk protein concentrate.

### Terms

Unless specifically defined otherwise, all technical and scientific terms used herein shall be taken to have the same meaning as commonly understood by one of ordinary skill in the art (e.g., chemistry, biochemistry, medicinal chemistry, microbiology and the like).

Unless specifically stated otherwise, or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the steps, features, compositions and compounds referred to or indicated in this specification, individually or collectively, and any and all combinations or any two or more of said steps or features.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

As used herein, the term “and/or”, e.g., “X and/or Y” shall be understood to mean either “X and Y” or “X or Y” and shall be taken to provide explicit support for both meanings or for either meaning, e.g. A and/or B includes the options: (i) A, (ii) B or (iii) A and B.

As used herein, the term about, unless stated to the contrary, refers to +/−20%, typically +/−10%, typically +/−5%, of the designated value.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be clearly understood that, although a number of prior art publications are referred to herein, this reference does not constitute an admission that any of these documents forms part of the common general knowledge in the art, in Australia or in any other country.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will prevail. In addition, the materials, methods, and examples are illustrative only and not intended to be limiting.

### Process for Preparing Dairy Food Gel Products

The present disclosure provides a process for preparing a plurality of dairy food gel products having a range of predetermined organoleptic properties from one or more ingredients, wherein at least one ingredient is a milk protein concentrate (MPC) or dairy food gel ingredient comprising an MPC.

The process may comprise the following steps:
selecting process conditions for one or more of the plurality of dairy food gel products having predetermined organoleptic properties, wherein the process conditions comprise predetermined parameters selected from liquid content, process temperature, and process duration;
processing the one or more ingredients according to the selected process conditions; and
obtaining one or more of the plurality of dairy food gel products having predetermined organoleptic properties based on the selected process conditions.

It will be understood that the term ‘plurality’ in the context of ‘a plurality of dairy food gel products’, refers to the variety of dairy food gel products described by the range of textures, organoleptic properties, physical properties, and the like, that may be produced according to the process of the present disclosure.

In some embodiments, the process conditions further comprise one or more of process mixing and process pressure application, which may be provided according to any embodiments or examples thereof as described herein. In some embodiments, the process conditions further comprise process mixing according to any embodiments or examples thereof as described herein. In some embodiments the process conditions consist of predetermined parameters selected from: liquid content, process temperature, process duration, optionally process mixing, and optionally process pressure application. In some embodiments, the process conditions consist of predetermined parameters selected from liquid content, process temperature, process duration, and optionally process mixing. In some embodiments the process conditions consist of predetermined parameters selected from: liquid content, process temperature, and process duration.

In some embodiments, the process for preparing a plurality of dairy food gel products further comprises or consists of one or more steps of the methods of producing an MPC ingredient or dairy food gel product comprising an MPC, according to any aspect, embodiment, or example thereof as described herein.

In some embodiments, there is provided a process for preparing a plurality of dairy food gel products with a range of predetermined organoleptic properties from one or more ingredients, wherein at least one ingredient is a milk protein concentrate (MPC) or dairy food gel ingredient comprising an MPC, wherein the process consists of the steps of:
selecting process conditions for one or more of the plurality of dairy food gel products having predetermined organoleptic properties, wherein the process conditions comprise or consist of predetermined parameters selected from liquid content, process temperature, and process duration, and optionally process mixing;
processing the one or more ingredients according to the selected process conditions; and
obtaining one or more of the plurality of dairy food gel products having predetermined organoleptic properties based on the selected process conditions.

In some embodiments, there is provided a process for preparing a plurality of dairy food gel products with a range of predetermined organoleptic properties from one or more ingredients, wherein at least one ingredient is a milk protein concentrate (MPC) or dairy food gel ingredient comprising an MPC, wherein the MPC is selected from a fermented MPC (fMPC), calcium reduced MPC (cMPC), and a fermented calcium reduced MPC (fcMPC), and wherein the process consists of the steps of:
selecting process conditions for one or more of the plurality of dairy food gel products having predetermined organoleptic properties, wherein the process conditions comprise or consist of predetermined parameters selected from liquid content, process temperature, and process duration, and optionally process mixing;
processing the one or more ingredients according to the selected process conditions; and
obtaining one or more of the plurality of dairy food gel products having predetermined organoleptic properties based on the selected process conditions.

In some embodiments, there is provided a process for preparing a plurality of dairy food gel products with a range of predetermined organoleptic properties from one or more ingredients, wherein at least one ingredient is a milk protein concentrate (MPC) or dairy food gel ingredient comprising an MPC, wherein the MPC is selected from a calcium reduced MPC (cMPC), and wherein the process consists of the steps of:
selecting process conditions for one or more of the plurality of dairy food gel products having predetermined organoleptic properties, wherein the process conditions comprise or consist of predetermined parameters selected from liquid content, process temperature, and process duration, and optionally process mixing;
processing the one or more ingredients according to the selected process conditions; and
obtaining one or more of the plurality of dairy food gel products having predetermined organoleptic properties based on the selected process conditions.

In some embodiments, there is provided a process for preparing a plurality of dairy food gel products with a range of predetermined organoleptic properties from one or more ingredients, wherein at least one ingredient is a fermented calcium reduced MPC (fcMPC) or dairy food gel ingredient comprising a fcMPC, wherein the process consists of the steps of:
selecting process conditions for one or more of the plurality of dairy food gel products having predetermined organoleptic properties, wherein the process conditions comprise or consist of predetermined parameters selected from liquid content, process temperature, and process duration, and optionally process mixing;
processing the one or more ingredients according to the selected process conditions; and
obtaining one or more of the plurality of dairy food gel products having predetermined organoleptic properties based on the selected process conditions.

In some embodiments, the one or more ingredients are selected from: one or more MPC, one or more dairy food gel ingredient(s) comprising an MPC, and optionally one or more additive ingredients, each of which may be provided according to any aspects, embodiments or examples thereof as described herein. The MPC or ingredient comprising an MPC may be a calcium reduced MPC (e.g. cMPC and/or fcMPC). The MPC or ingredient comprising an MPC may be a fermented MPC (e.g. fMPC and/or fcMPC). In one embodiment, the MPC or ingredient comprising an MPC is an fcMPC. In embodiments where the MPC is an cMPC or fcMPC, it will be appreciated any other MPC may be used as an additional ingredient, optionally with any one or more additive ingredients.

In one example, the one or more ingredients provides a source of dairy protein consisting of one or more MPC and one or more dairy food gel ingredient(s) comprising an MPC and optionally one or more additive ingredients. In another example, the one or more ingredients provides a source of dairy protein selected from the group consisting of one or more MPC and one or more dairy food gel ingredient(s) comprising an MPC. The MPC may be a cMPC, for example a fcMPC.

In some examples, the MPC (e.g. cMPC, fMPC, or fcMPC) may have a casein to whey ratio of less than about 90:10, 89:11, 88:12, 87:13, 86:14, 85:15, 8 84:16, 83:17, 82:18, 81:19, or 80:20. In some examples, the MPC (e.g. cMPC, fMPC, or fcMPC) may have a casein to whey ratio of between about 70:30 to about 90:10, 71:29 to about 89:11, between about 72:28 to about 88:12, between about 73:27 to about 87:13, between about 74:26 to about 86:14, between about 75:25 to about 85:15, between about 76:24 to about 84:16, between about 77:23 to about 83:17, between about 78:22 to about 82:18, between about 79:21 to about 81:19, or between about 80:20 and 85:15.

In some embodiments, the sole source of dairy protein is provided by an MPC ingredient. For example, the MPC ingredient does not comprise or consist of any other dairy proteins such as whey protein isolate (WPI), micellar casein concentrate (MCC), caseinates, or analogues thereof. In other examples the one or more ingredients, or any one or more additives thereof, if present, do not include any other source of dairy protein such as a natural cheese (e.g. cheddar cheese) or product thereof.

It will be understood that the dairy food gel product and/or dairy food gel ingredient may be provided according to any one of the embodiments or examples thereof as described herein.

### Process Conditions

Formation of the dairy food gel product from the one or more ingredients can be induced by adding liquid (e.g. water) to the ingredients, followed by heating (e.g. indirect heat or directly by the addition of culinary steam) for a specified duration (e.g. at least 1 minute).

The one or more ingredients may be combined in any order prior to processing the ingredients according to the selected process conditions to transform the ingredients into the dairy food gel. In some embodiments, the process further comprises a step of pre-processing the one or more ingredients. Pre-processing will be understood to encompass any and all combining, mixing, heating, hydrating, etc. of the one or more ingredients that occurs prior to the step of processing the one or more ingredients according to the selected process conditions (viz, the step of transforming the one or more ingredients into the dairy food gel product). Such pre-processing may comprise one or more of pre-mixing, pre-heating or pre-hydrating, which may be performed at the same time or separately, for a particular duration(s) of time and/or at a particular temperature(s). In some embodiments, the pre-processing (and/or pre-mixing and/or pre-heating and/or pre-hydrating) is for a duration of time (in min) less than 30, 25, 20, 15, 10, 9, 8, 7, 6, 5, 4, 3, 2 or 1. In some embodiments, the process does not comprise any pre-mixing of the one or more ingredients. In some embodiments, the process does not comprise any pre-heating of the one or more ingredients. In some embodiments, the process does not comprise any pre-hydration of the one or more ingredients. In some embodiments, the process does not comprise any pre-processing of the one or more ingredients. The one or more ingredients may comprise or consist of solid or dry ingredients, which may be mixed together prior to or at the same time as liquid addition. In other words, in one example there may be provided a ‘one-pot’ process to form a dairy food gel product.

The ingredients may be placed in any container, receptacle, vessel, bag, tray, etc. suitable for processing according to the selected process conditions (e.g. suitable for heating to and/or at the predetermined temperature for the predetermined duration). Optionally, the ingredients may be processed in the course of processing another food ingredient. For example, the ingredients may be mixed with added water to form a paste, which may be placed on or in another food item e.g. a sandwich, a bun, lasagne, to be transformed to the dairy food gel product as the food item is cooked or heated. A person skilled in the art will appreciate that there is a plethora of common household or industrial devices that are suitable for applying heat and/or the optional mixing for the transformation of the ingredient mixture into a dairy food gel product. Non-limiting examples include an oven, a toast oven, a microwave oven, a Thermomix®, industrial sized mixers (e.g. planetary mixers, spiral mixers, vertical mixers, ribbon mixers, high-shear mixers, and continuous mixers), and other heat generating appliances. The equipment described herein is not intended to limit the scope of this disclosure.

Optionally, agitation and/or mechanical mixing may be applied to effect transformation of the ingredients to the dairy food gel. Thus, in some embodiments, the process conditions further comprise process mixing. The level of agitation and/or mixing is selected to further enhance or control the production of a food gel, which on cooling has the desired body, texture, fat globule size and melt characteristics. To produce a dairy food gel with a texture similar to certain varieties of cheese, mixing may be used in some examples to further enhance the production thereof.

A person skilled in the art will appreciate that process mixing involves control of the mechanical working conditions (e.g. shear rate) of the processing the one or more ingredients. The optimal mixing process may vary depending on the desired texture and properties of the dairy food gel product. The application of shear may be used to further modulate texture that primarily appears as different functional properties of the product e.g. meltability, flow and viscosity. For example, to produce a dairy food gel product with texture similar to a sauce, the shear rate may be greater than about 500 s⁻¹. In a further example, firmness may be increased by using a higher shear rate (e.g. 1200 rpm). Optionally, shear rates may be varied during the gelation process. For example, a combination of shear (for example, high shear, or low shear) and time can be used to further modulate the texture of the dairy food gel product.

In some embodiments, the process mixing comprises shear process mixing with a shear rate (in rpm or s⁻¹) greater than about 100, 200, 300, 400, 500, 600, 700, 800, 900, 1000, 1100, 1200, 1300, 1400 or 1500. In some embodiments, the process mixing comprises shear process mixing with a shear rate (in rpm or s⁻¹) less than about 1500, 1400, 1300, 1200, 1100, 1000, 900, 800, 700, 600, 500, 400, 300, 200 or 100. In some embodiments, the process mixing comprises shear process mixing with a shear rate (in rpm or s⁻¹) in a range provided by any two of the previously described upper and/or lower amounts, for example, the process mixing comprises shear process mixing with a shear rate (in rpm or s⁻¹) between about 100 and about 1500, between about 1000 and about 1500, or between about 100 and about 500. In some embodiments, the process mixing comprises low shear process mixing (a shear rate less than 500 s⁻¹). In some embodiments, the process mixing comprises high shear process mixing (a shear rate in excess of 500 s⁻¹). In some embodiments, the process mixing is at a shear rate greater than 1000 s⁻¹. In some embodiments, the process conditions do not comprise process mixing viz. that no additional mechanical mixing of the water and ingredient is required, and that diffusive water filtration through the ingredients on additive are sufficient for transformation. In one example, the process further comprises a step of pre-processing, optionally pre-mixing and/or pre-heating and/or pre-hydrating, and the process conditions do not comprise process mixing. In other words, in some examples, the ingredients may be mixed prior to the processing step in which the transformation of the ingredients into the dairy food gel ingredient occurs but does not require mixing.

In some embodiments, the process conditions further comprise process pressure application. It will understood that the pressure at which the processing is performed may be predetermined and controlled. Pressure may be described as high pressure (greater than atmospheric pressure), low pressure (lower than atmospheric pressure), or about atmospheric pressure. In some examples, low pressure may be described as a vacuum, viz, the processing is performed under vacuum. In one example, the processing is not performed at high pressure. In some embodiments, the process conditions do not comprise process pressure viz. that the pressure at which the process is performed is not selected or predetermined.

In some embodiments, the process conditions do not comprise process fermentation viz. no fermentation is performed during processing of the one or more ingredients.

In some embodiments, the process conditions do not comprise enzymatic treatment viz. no enzymatic treatment (e.g. renneting) is performed during processing of the one or more ingredients.

In some embodiments, the process further comprises one or more steps towards preparing the cMPC, fMPC, or fcMPC ingredient, wherein such one or more steps may be selected from those according to any aspect, embodiment or example as described herein. In some embodiments, the process further comprises one or more steps towards preparing the fcMPC ingredient, wherein such one or more steps may be selected from those according to any aspect, embodiment described herein.

The dairy food gel products can, if desired, be further processed, e.g. the cheese-like dairy food gel products can be processed using standard processed cheese manufacturing techniques to produce processed cheese-like products.

### Liquid Content

Liquid content refers to the amount of liquid used in the processing of the one or more ingredients. Typically, liquid content refers to water content, however a person skilled in the art will appreciate that milk, cream, and other non-dairy liquids including but not limited to vegetable oils (such as canola, corn, soybean, sunflower), olive oil, avocado oil, coconut oil, grapeseed oil, sesame oil, peanut oil, flaxseed oil, may be used as an alternative to water.

Liquid content may be defined by its water content regardless of the type of liquid used. Water content refers to the amount of water utilised in the processing of the ingredients. It is to be appreciated that the ingredients may also comprise water which will contribute to the water content. ‘Water content’ may be described in terms of the total amount of water in a dairy food gel product or plurality thereof, expressed as a weight percentage relative to the total weight of all components of the dairy food gel product, or plurality thereof. In some embodiments, the water content (in % w/w) is less than about 100, 99, 95, 90, 85, 80, 75, 70, 65, 60, 55, 50, 45, 40, 35, 30, 25, 20, 15, 10, 5, or 1. In some embodiments, the water content (in % w/w) is greater than about 0, 1, 5, 10, 15, 20, 25, 30, 35, 40, 45, 50, 55, 60, 65, 70, 75, 80, 85, 90, 95, or 99. In some embodiments, the water content (in % w/w) is in a range provided by any of the previously described upper and/or lower amounts, for example, the water content (in % w/w) is between about 1 to 99, 20 to 95, or 40 to 90. In some examples, the liquid content is water. In some examples, the one or more ingredients comprise or consist of solids or dry mixtures, and the liquid content is provided by an addition of water.

The water content may be adjusted by adding water (for example, in the form of a liquid, spray or steam) directly to the one or more ingredients. This addition may take place at any point in the process. The water may be added to one or more ingredients to form a slurry or a paste prior to further combining with other ingredients, or processing. For example, water may be sprayed into an MPC powder, at about room temperature (15 to 35° C.) to form a slurry or a paste, which may either be combined with further ingredients, processed immediately or stored under refrigerated conditions for later use.

Thus, in some embodiments, the processing of the one or more ingredients according to the selected process conditions comprise providing an amount of water; and combining the amount of water with at least one of the one or more ingredients. In some examples, the one or more ingredients may each comprise or consist of solids or dry mixtures.

To assist in achieving the desired process temperature, optionally the water may be pre-heated prior to combination with at least one of the one or more ingredients. Thus, in some embodiments, the provided amount of water is at a temperature (in ° C.) less than about 150, 145, 140, 135, 130, 125, 120, 115, 110, 105, 100, 95, 90, 85, 80, 75, 70, 65, 60, 55, 50, 45, 40, 35, 30, 25, 20, 15, 10, 5, or 1. In some embodiments, the provided amount of water is at a temperature (in ° C.) greater than about 0, 1, 5, 10, 15, 20, 25, 30, 35, 40, 45, 50, 55, 60, 65, 70, 75, 80, 85, 90, 95, 100, 105, 110, 115, 120, 125, 130, 135, 140, or 145. It will be appreciated the water temperature may be measured during the process, which may involve various external temperatures and optional pressures. For example, the water content may be provided by superheated steam. In some embodiments, the provided amount of water is at a temperature (in ° C.) in a range provided by any two of the previously described upper and/or lower amounts, for example, the provided amount of water is at a temperature (in ° C.) between about 1 to 100, 40 to 95, 50 to 95, 60 to 95, 60 to 90, or 65 to 85.

### Process Temperature

Process temperature refers to the temperature of the environment in which the processing of the ingredients is performed. Process temperature can be selected to apply heat for a duration of time, to transform the ingredient mixture into a dairy food gel product.

In some embodiments, the process temperature (in ° C.) is less than about 500, 400, 300, 250, 200, 180, 160, 140, 120, 100, 80, 60, 55, 50, 45, 40, 20, 15, 10, 5, or 1. In some embodiments, the process temperature (in ° C.) is greater than about 1, 5, 10, 15, 20, 40, 45, 50, 55, 60, 80, 100, 120, 140, 160, 180, 200, 250, 300, 400, or 500. In some embodiments, the process temperature (in ° C.) is in a range provided by any two of the previously described upper and/or lower amounts, for example, the process temperature (in ° C.) may be between about 1 to 500, 45 to 300, 50 to 500, 55 to 200, or 50 to 95. It will be appreciated that the process temperature may be kept at a constant temperature for the entire duration of the processing. Alternatively, the process temperature may be varied across the process duration, which can be described in terms of a sequence of corresponding temperatures and durations, for example, the process temperature may be about 200° C. for 1 minute, followed by 160° C. for 3 minutes. It will be appreciated that the process temperature refers to the process condition environment under which the ingredients are exposed.

Alternatively, process temperature describes the temperature of the ingredients and/or gel during processing (‘the gel temperature’). In some embodiments, the gel temperature (in ° C.) is less than about 200, 195, 190, 185, 180, 175, 170, 165, 160, 155, 150, 145, 140, 135, 130, 125, 120, 115, 110, 105, 100, 95, 90, 85, 80, 75, 70, 65, 60, 55, 50, 45, 40, 35, 30, 25, 20, 15, 10, 5, or 1. In some embodiments, the gel temperature (in ° C.) is greater than about 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, or 195. In some embodiments, the gel temperature (in ° C.) is in a range provided by any two of the previously described upper and/or lower amounts, for example, the gel temperature (in ° C.) is between about 1 to 200, 5 to 100, 40 to 95, 50 to 95, 55 to 95, 60 to 95, 60 to 90, or 65 to 85. It will be appreciated that the gel temperature may be kept at a constant temperature for the entire duration of the processing. Alternatively, the gel temperature may vary throughout the process duration as required, which may described in terms of a sequence of corresponding temperatures and durations, for example, the gel temperature may be about 60° C. for 1 minute, followed by 70° C. for 3 minutes. Although the dairy food gel product will form if the temperature exceeds 40° C., a temperature in excess of 55° C. will typically be used for reasons of food safety. In some examples, the process temperature may include UHT processing conditions.

It will be appreciated that a range of sources of heat may be used to provide the temperature, such as conduction, radiation (e.g. microwave), and convection sources. In some examples, there may be indirect heat or direct heating such as by use of culinary steam.

### Process Duration

Process duration refers to the duration for which heat is applied at a given temperature during the processing of the ingredients.

In some embodiments, the process duration (in min) is at least about 1, 2, 3, 4, 5, 6, 7, 8, 9, 10, 14, 20, 25, 30, 40, 45, 50, 55, or 60. In some embodiments, the process duration (in min) is less than about (60, 55, 50, 45, 40, 35, 30, 25, 20, 15, 10, 9, 8, 7, 6, 5, 4, 3, 2, or 1. In some embodiments, the process duration (in min) is in a range provided by any two of the previously described upper and/or lower amounts, for example, the process duration (in min) is between 1 to 60, 1 to 45, 2 to 15, 4 to 6, 1 to 5, 2 to 4, or 1 to 3. In some examples, the process duration (in seconds) may be less than about 1000, 750, 500, 250, 100, 90, 80, 70, 60, 50, 40, 30, 20, 15, 10, or 5. In some examples, the process duration (in seconds) may be at least about 1, 5, 10, 15, 20, 30, 40, 50, 60, 70, 80, 90, 100, 250, 500, or 750. In some examples, the process duration may be in a range provided by any two above amounts such as 100 seconds to 10 minutes, 10 seconds to 2 minutes, 30 seconds to 500 seconds, or 5 seconds to 30 seconds. It will be appreciated that as in some embodiments the process temperature may vary throughout the process duration, the process temperature and process duration may be described together as a sequence of corresponding temperatures and durations, for example, the process temperature may be about 60° C. for 1 minute, followed by 70° C. for 3 minutes. In some examples the process temperature may be applied constantly for the duration, in sequential increments, or intermittently for the duration or part thereof. In other examples, the process duration (in hours) is less than about 48, 40, 32, 24, 16, 8, 5, 4, 3, 2, or 1.

It will be appreciated by persons skilled in the art that selection of particular process temperatures may either enable or require transformation of the ingredients into the dairy food gel product to occur at particular process durations. For example, process temperature of e.g. 70° C. or more, may allow for a shorter process duration of e.g. 3 minutes, in order for the transformation of the ingredients into the dairy food gel product to occur. In another example, a process temperature of e.g. 35° C., may require a longer process duration of e.g. 24 hours or more, in order for the transformation of the ingredients into the dairy food gel product to occur.

### Process Scale

A person skilled in the art will appreciate that the process for preparing a plurality of dairy food gel products may be performed at a variety of scales, by which is meant the size, scale or amount of ingredient input and/or product output. The scale at which the process is performed may be described, for example, in terms of the total mass of the one or more ingredients and/or dairy food gel product. Accordingly, in some embodiments the amount of ingredient and/or obtained product (in kg) is less than about 10000, 7500, 5000, 2500, 1000, 500, 200, 100, 50, 20, 10, 5, 1, 0.5, 0.25, 0.1, 0.01, or 0.001. In some embodiments the amount of ingredient and/or obtained product (in kg) is greater than about 0.001, 0.01, 0.1, 0.25, 0.5, 1, 5, 10, 20, 50, 100, 200, 500, 1000, 2500, 5000, 7500, or 10000. In some embodiments, the amount of ingredient and/or obtained product (in kg) is in a range provided by any two of the previously described upper and/or lower amounts, for example, the amount of ingredient and/or obtained product (in kg) is between about 0.001 to 10000.

A person skilled in the art will appreciate that the process for preparing a plurality of dairy food gel products may be performed in either batch or flow production. Where performed in flow production, the scale of the process may be described in terms of the mass output, which describes the total mass of dairy food gel product produced, as a function of time (in MT/h). Accordingly, in some embodiments the mass output (in MT/h) is less than about 50, 40, 30, 20, 10, 5, 1, 0.5, 0.25, 0.1, 0.01, or 0.001. In some embodiments the mass output (in MT/h) is greater than about 0.001, 0.01, 0.1, 0.25, 0.5, 1, 5, 10, 20, 30, 40, or 50. In some embodiments, the mass output (in MT/h) is in a range provided by any two of the previously described upper and/or lower amounts, for example, the mass output (MT/h) is between about 0.001 to 50, 0.01 to 30, or 1 to 10.

### Method of Modulating Texture

It has also been found that dairy food gel products of a variety of textures can be produced according to a method of the present disclosure. The texture of the produced dairy food gel product is determined by the combination of features including the processing conditions (e.g. process temperature, process duration, and liquid content) and the composition of the MPC or dairy food gel ingredient comprising an MPC (without limitation, but in particular, the monovalent to divalent cation ratio, cationic balance, calcium content, and fat content). Without-limiting the scope of the present disclosure, Examples 1 and 2 provide examples of dairy food gel products with a variety of organoleptic properties, produced through control of the processing conditions, and composition of an MPC or dairy food gel ingredient comprising an MPC.

Thus, the present disclosure also provides a method of modulating the texture of a mixture of one or more ingredients, or a product prepared therefrom, wherein at least one ingredient is a milk protein concentrate (MPC) or dairy food gel ingredient comprising an MPC, and wherein the method comprises the steps of:
selecting process conditions, wherein the process conditions comprise predetermined parameters selected from liquid content, process temperature, and process duration;
processing the one or more ingredients according to the selected process conditions to form a dairy food gel product having predetermined texture based on the selected process conditions; and
obtaining the dairy food gel product.

In some embodiments, the process conditions further comprise one or more of process mixing and process pressure application, which may be provided according to any embodiments or examples thereof as described herein. In some embodiments, the process conditions further comprise process mixing according to any embodiments or examples thereof as described herein. In some embodiments the process conditions consist of predetermined parameters selected from: liquid content, process temperature, process duration, optionally process mixing, and optionally process pressure application. In some embodiments, the process conditions consist of predetermined parameters selected from liquid content, process temperature, process duration, and optionally process mixing. In some embodiments the process conditions consist of predetermined parameters selected from: liquid content, process temperature, and process duration.

In some embodiments, the method of modulating texture further comprises or consists of one or more steps of the methods of producing an MPC ingredient or dairy food gel product comprising an MPC, according to any aspect, embodiment, or example thereof as described herein.

In some embodiments, the method of modulating texture consists of the steps of:
selecting process conditions for one or more of the plurality of dairy food gel products having predetermined organoleptic properties, wherein the process conditions comprise or consist of predetermined parameters selected from liquid content, process temperature, and process duration, and optionally process mixing;
processing the one or more ingredients according to the selected process conditions; and
obtaining one or more of the plurality of dairy food gel products having predetermined organoleptic properties based on the selected process conditions.

It will be understood that the dairy food gel product may be provided according to any embodiments or examples thereof as described herein.

In some embodiments, the one or more ingredients are selected from: MPC, dairy food gel ingredient comprising an MPC, and optionally one or more additive ingredients, which may be provided according to any aspects, embodiments or examples thereof as described herein.

In some embodiments, the method of modulating the texture of a mixture of one or more ingredients, further comprises or consists of one or more steps of the methods of producing an MPC ingredient or dairy food gel comprising an MPC ingredient, according to any aspect, embodiment, or example thereof as described herein.

### Dairy Food Gel Ingredients

The present disclosure also provides for a dairy food gel ingredient comprising or consisting of a milk protein concentrate (MPC), and optionally one or more additive ingredients. In some examples, the dairy food gel ingredient consists of a milk protein concentrate (MPC) and one or more additive ingredients.

It will be understood that the dairy food gel ingredient comprising an MPC, may comprise any milk protein concentrate, including an MPC according to any aspect, embodiments, or examples thereof as described herein.

It will also be understood that the one or more additive ingredients may be provided according to any aspect, embodiment, or examples thereof as described herein. For example, the one or more additive ingredients may be selected from any one or more of: fats, mineral salt, food acid, flavourings, colourants, sweeteners, emulsifiers, stabilisers, thickeners, protein, prebiotics, probiotics, and postbiotics. In one example, the one or more additive ingredients may be selected from any one or more of: fats, mineral salt, and food acid, flavourings. In another example, the one or more additive ingredients may be selected from flavourings, colourants, sweeteners, emulsifiers, stabilisers, thickeners, and acidity regulators. In another example, the one or more additive ingredients may be selected from colourants, stabilisers, thickeners, and acidity regulators. In another example, the one or more additives may be selected from dairy additives (e.g. protein concentrates, butter, non-fat dry milk) and non-dairy additives (e.g. minerals, salts, colours, flavours). In one example, the dairy additive (or any of the one or more ingredients) does not comprise any natural cheeses or products thereof (e.g. cheddar cheese). It will be appreciated that the present dairy gel products do not require the addition of natural cheeses to obtain suitable texture and flavour attributes. In another example, the dairy additive does not include any source of dairy protein (e.g. MCC). In another example, the one or more additives may be selected from non-dairy additives (e.g. minerals, salts, colours, flavours). Further embodiments and examples of the one or more additives are described below and herein.

In some examples, any additional ingredient dairy protein or source of dairy protein, if present, has a casein to whey ratio between about 70:30 to about 90:10, 71:29 to about 89:11, between about 72:28 to about 88:12, between about 73:27 to about 87:13, between about 74:26 to about 86:14, between about 75:25 to about 85:15, between about 76:24 to about 84:16, between about 77:23 to about 83:17, between about 78:22 to about 82:18, between about 79:21 to about 81:19, or between about 80:20 and 85:15.

In some embodiments, there is provided a process for preparing a plurality of dairy food gel products with a range of predetermined organoleptic properties using a limited number of ingredients introduced into the process, for example any number of ingredients between 1 and 10 ingredients, such as, or less than, 10, 9, 8, 7, 6, 5, 4, 3, or 2 ingredient(s). In some examples, the number of ingredients is in a range provided by any of the previously described amounts, for example between 1 and 10, 1 to 5, or 1 to 3 ingredient(s). In one example, there is a process for preparing a plurality of dairy food gel products with a range of predetermined organoleptic properties from a single ingredient. It will be appreciated that at least one ingredient in the process comprises or consists of an MPC, which may be provided according to any aspects, embodiments or examples thereof as described herein (e.g. fcMPC). Each ingredient may be one or more dairy food gel ingredients, which may include an MPC optionally with one or more additive ingredients (e.g. additive ingredients concurrently or sequentially admixed with MPC into a single ingredient).

In some embodiments, at least one of the one or more ingredients used in the process comprises or consists of an MPC. In some embodiments, at least one of the one or more ingredients used in the process comprises or consists of a calcium-reduced MPC (cMPC). In some embodiments, at least one of the one or more ingredients used in the process comprises or consists of a fermented and calcium-reduced MPC (fcMPC). In some embodiments, at least one of the one or more ingredients used in the process is a dairy food gel ingredient according to any aspect, embodiment, or examples thereof as described herein. The person skilled in the art will appreciate that the ingredients to be used in the process are described as to their state prior to the step of processing the one or more ingredients to transform them into the dairy food gel product. For example, where at least one ingredient is a fermented and calcium reduced MPC (fcMPC), the fcMPC ingredient is both fermented and calcium-reduced prior to its combination with the rest of the ingredients and processing into the dairy food gel product.

In some embodiments, the one or more ingredients used in the process each comprise or consist of an MPC, and optionally one or more additives according to any embodiments or examples thereof as described herein. In one example, the one or more ingredients at least comprise a calcium reduced MPC (e.g. cMPC and/or fcMPC), optionally any other type of MPC or ingredient comprising an MPC, and optionally one or more additives according to any embodiments or examples thereof as described herein. In one example, the one or more ingredients at least comprise a fermented MPC (e.g. fcMPC), optionally any other type of MPC or ingredient comprising an MPC, and optionally one or more additives according to any embodiments or examples thereof as described herein. In one example, the one or more ingredients comprise or consist of a calcium reduced MPC (e.g. cMPC and/or fcMPC) and optionally one or more additives according to any embodiments or examples thereof as described herein. In one example, the one or more ingredients comprise or consist of a fermented MPC (e.g. fcMPC) and optionally one or more additives according to any embodiments or examples thereof as described herein. In some examples, the one or more ingredients used in the process each comprise or consist of a fermented MPC (e.g. fcMPC), which excludes any non-fermented MPC. It will be understood that a non-fermented MPC is an MPC that has not been prepared and/or modified by a process involving fermentation.

In some embodiments, the one or more ingredients used in the process comprise at least two MPCs wherein at least one MPC is an fcMPC. In such embodiments, the fcMPC and (non-fermented) MPC (e.g. cMPC) may be present in a ratio greater than about 2:1, 2.1:1, 2.2:1, 2.3:1, 2.4:1, 2.5:1, 2.6:1, 2.7:1, 2.8:1, 2.9:1, 3:1:1, 3.5:1, 4:1, 4.5:1, 5:1, 5.5:1, 6:1, 6.5:1, 7:1, 7.5:1, 8:1, 8.5:1, 9:1, 9.5:1, 10:1, 15:1, 20:1, 25:1, 30:1, 35:1, 40:1, 45:1, 50:1, 60:1, 70:1, 80:1, 90:1, 95:1, 98:1 or 99:1. In some embodiments, the fcMPC and the (non-fermented) MPC are present in a ratio range provided by any two of the previously described amounts, for example, the ratio of the fcMPC to the non-fermented MPC may be between about 2:1 and about 99:1, between about 2.1:1 and about 50:1, or between about 2.5:1 and about 20:1.

In other examples, the fcMPC and non-fermented MPC may be present in a ratio less than about 1.5:1, 1.4:1, 1.3:1, 1.2:1, 1.1:1, 1:1, 1:1.1, 1:1.2, 1:1.3, 1:1.4, 1:1.5, 1:1.6, 1:1.7, 1:1.8, 1:1.9, 1:2, 1:2.1, 1:2.2, 1:2.3, 1:2.4, 1:2.5, 1:2.6, 1:2.7, 1:2.8, 1:2.9, 1:3, 1:3.5, 1:4, 1:4.5, 1:5, 1:5.5, 1:6, 1:6.5, 1:7, 1:7.5, 1:8, 1:8.5, 1:9, 1:9.5, 1:10, 1:15, 1:20, 1:25, 1:30, 1:35, 1:40, 1:45, 1:50, 1:60, 1:65, 1:70, 1:75, 1:80, 1:85, 1:90, 1:95, 1:98, 1:99. In some embodiments, the fcMPC and the non-fermented MPC are present in a ratio in a range provided by any two of the previously described amounts, for example, the ratio of the fcMPC to the non-fermented MPC is between about 1.5:1 and about 1:99, between about 1.4:1 and about 1:50, or between about 1:1 and about 1:20.

The one or more ingredients in the process may be selected from any ingredient suitable for inclusion in a food product, for example, an ingredient may be Generally Recognised As Safe (GRAS) substance. It will be understood that the one or more ingredients may be selected from multiple ingredients of the same type, e.g. one, two, three, or more of the one or more ingredients may be an MPC, or dairy food gel comprising an MPC.

In some embodiments, the one or more ingredients (including any additives if present) do not comprise cheese, such as a natural cheese (e.g. cheddar cheese), or a dairy product produced from such a cheese. In some embodiments, the one or more ingredients (including any additives if present) do not comprise any additional dairy proteins (e.g. MCC) other than an MPC as described herein (e.g. fcMPC). It will be appreciated that the present process does not require the addition of a natural cheese to achieve suitable flavours to the dairy food gel products described herein.

In one example, the dairy food gel ingredient comprises or consists of:
an MPC according to any aspect, embodiment, or example thereof as described herein; and
optionally one or more additive ingredients selected from the group consisting of: fats, mineral salt, food acid, flavourings, colourants, sweeteners, emulsifiers, stabilisers, thickeners, protein, prebiotics, probiotics, and postbiotics.

In another example, the dairy food gel ingredient comprises or consists of:
an MPC according to any aspects, embodiments, or examples thereof as described herein;
a mineral salt additive ingredient according to any embodiments or examples thereof as described herein; and
optionally one or more additive ingredients selected from the group consisting of: fats, food acid, flavourings, colourants, sweeteners, emulsifiers, stabilisers, thickeners, protein, prebiotics, probiotics, and postbiotics.

In another example, the dairy food gel ingredient comprises or consists of:
an MPC according to any aspect, embodiments, or examples thereof as described herein;
a mineral salt additive ingredient according to any embodiments or examples thereof as described herein;
a food acid additive ingredient according to any embodiments or examples thereof as described herein; and
optionally one or more additive ingredients selected from the group consisting of: fats, flavourings, colourants, sweeteners, emulsifiers, stabilisers, thickeners, protein, prebiotics, probiotics, and postbiotics.

In one example, the dairy food gel ingredient comprises or consists of:
an MPC according to any aspects, embodiments, or examples thereof as described herein;
a fat additive ingredient according to any embodiments or examples thereof as described herein; and
optionally one or more additive ingredients selected from the group consisting of: mineral salt, food acid, flavourings, colourants, sweeteners, emulsifiers, stabilisers, thickeners, protein, prebiotics, probiotics, and postbiotics.

In another example, the dairy food gel ingredient comprises or consists of:
an MPC according to any aspects, embodiments, or examples thereof as described herein;
a fat additive ingredient according to any embodiments or examples thereof as described herein; and
a mineral salt additive ingredient according to any embodiments or examples thereof as described herein; and
optionally one or more additive ingredients selected from the group consisting of: food acid, flavourings, colourants, sweeteners, emulsifiers, stabilisers, thickeners, protein, prebiotics, probiotics, and postbiotics.

In another example, the dairy food gel ingredient comprises or consists of:
an MPC according to any aspect, embodiments, or examples thereof as described herein;
a fat additive ingredient according to any embodiments or examples thereof as described herein; and
a mineral salt additive ingredient according to any embodiments or examples thereof as described herein;
a food acid additive ingredient according to any embodiments or examples thereof as described herein; and
optionally one or more additive ingredients selected from the group consisting of: flavourings, colourants, sweeteners, emulsifiers, stabilisers, thickeners, protein, prebiotics, probiotics, and postbiotics.

If present, the one or more additive ingredients (separately or combined) may be provided in an amount (based on wt % of total ingredients, excluding water) of less than about 50, 45, 40, 35, 30, 25, 20, 15, 10, 9, 8, 7, 6, 5, 4, 3, 2, or 1. The one or more additive ingredients may be provided in any range between any two of the previous amounts. For example, if present any additional dairy ingredients may be provided in an amount of less than about 10, 9, 8, 7, 6, 5, 4, 3, 2, or 1, or any range between any two of those amounts (e.g. between about 1 and 10 or between about 1 and 5). Any of the one or more MPC (or ingredient comprising MPC) may therefore be provided in an amount (based on wt % of total ingredients including any additives if present, excluding water) of at least about 50, 55, 60, 65, 70, 75, 80, 85, 90, 95, 96, 97, 98, or 99, or in any range therebetween.

### Additive Ingredients

It will be appreciated that an additive ingredient may be any ingredient, substance, or composition, suitable for inclusion in a food product. In one example, additive ingredients are selected from any Generally Recognised As Safe (GRAS) substance.

It will be understood that an additive ingredient may be a compound, or a blended composition, such as comprising from 1 to 100 individual components. For example, certain spice blends may comprise as many as 1, 2, 3, 4, 5, 10, 25, 50, 75, or 100 individual spices.

In some embodiments the additive ingredient is selected from the group consisting of antioxidant, artificial sweeteners, carbohydrate, emulsifiers, fats, acids, colourants, dietary supplements, humectants, enzymes, flavourings, flavour enhancers, foaming agents, herbs, mineral salts, prebiotics, probiotics, postbiotics, preservatives, protein, thickeners and vegetable gums, spices, stabilisers and firming agents, sweeteners, vitamins, glazing agents, gelling agents, propellants, raising agents, bulking agents.

In some embodiments the additive ingredient is selected from the group consisting of emulsifiers, fats, dietary supplements, food acids, flavourings, flavour enhancers, herbs, mineral salts, prebiotics, probiotics, postbiotics, preservatives, protein, thickeners, spices, stabilisers, firming agents, and sweeteners.

In some embodiments the additive ingredient is selected from the group consisting of fats, mineral salt, food acid, flavourings, colourants, sweeteners, emulsifiers, stabilisers, thickeners, protein, prebiotics, probiotics, and postbiotics.

In some embodiments the additive ingredient is selected from the group consisting of fats, mineral salt, food acid, flavourings, colourants, sweeteners, emulsifiers, stabilisers, thickeners.

In some embodiments the additive ingredient is selected from the group consisting of food acid, flavourings, colourants, sweeteners, emulsifiers, stabilisers, thickeners.

In some embodiments the additive ingredient is selected from the group consisting of butter, cream, citric acid, lactic acid, sodium chloride, calcium chloride, cheese flavour (e.g. blue cheese flavour), stabilisers, lactose, and granulated sugar.

In some embodiments, the additive ingredient does not comprise a natural cheese (e.g. cheddar cheese), or a dairy product produced from such a cheese. In some embodiments, the additive ingredient does not comprise any additional dairy proteins (e.g. MCC). It will be appreciated that the present process does not require the addition of a natural cheese or additional dairy protein (other than an MPC as described herein) to achieve suitable flavours to the dairy food gel products described herein. In some examples, the additive ingredient does not comprise an emulsifier.

It will be appreciated by a person skilled in the art that the combination of additive ingredients for inclusion in the dairy food gel product, and the amount of each additive ingredient, may be selected to regulate the organoleptic properties of the dairy food gel product.

Food acids can be included to regulate the pH of the finished dairy food gel product to a desired level. The acidity of the dairy food gel product can be controlled to help regulate the melting characteristics of the finished product, as well as taste. Various food acids can be employed; non-limiting examples include, adipic acid, lactic acid, citric acid, tartaric acid, malic acid, fumaric acid, and acetic acid. A food acid is typically included to regulate the pH of the finished product to a pH from about 4-7, and more typically from pH 5-6.

Colourants can be included to adjust the colour of the dairy food gel product. This can be useful, for example, if consumers have a preference for a colour other than the naturally-occurring colour. The amount of colourant added is typically in the range of about 0.001 to 2%, or 0.01-2% based on the weight of the finished cheese. Examples of suitable colourants include annatto, tumeric, titanium dioxide, and beta-carotene. Tumeric, for example, imparts a yellowish colour, which may be desirable if the dairy food gel product is a mozzarella-style dairy food gel product. The yellowish colour often is preferred by consumers who perceive it to indicate a “richer” product upon cooking on a pizza. Tumeric, if used, is generally added in an amount of about 0.05 to 0.2 wt. %.

Enzymes may be utilised to influence various organoleptic properties of the dairy food gel product, e.g. to adjust texture through protein cross-linking. Suitable enzymes for this purpose include, but are not limited to transglutaminases. The amount of enzyme added typically ranges from about 0.01-1.0 wt. %. Flavour producing enzymes and cultures may be added to regulate taste of the finished product.

Mineral salts of various types may be utilised as an additive ingredient. Mineral salts may be included to regulate flavour, firmness, or melting characteristic of the dairy food gel product. Mineral salts can include a mineral component and optionally a non-mineral component. The mineral component typically binds to the non-mineral component, or is at least capable of binding to the non-mineral component, although the formation of such a bond is not required. The non-mineral component, if present, thus can be selected from any chemical species capable of binding or associating with the mineral component to form a salts. In some embodiments, the mineral salt is a calcium or sodium salt, e.g. such as calcium chloride, or sodium chloride. In addition, melting salts typically used in processed cheese manufacture, for example but not limited to sodium phosphate salts as known in the art, are not required to achieve gel formation.

Flavourings can also be incorporated into the dairy food gel product to tailor the flavour profile of the dairy food gel product to meet consumer preferences. As will be appreciated by a person skilled in the art, flavourings may be described in terms of flavor descriptors, non-limiting examples of which include sweet, sour, bitter, umami, fruity, floral, spicy and nutty. Flavourings may also be described by reference to certain dairy products, non-limiting examples of which include cheddar cheese flavour, parmesan cheese flavour, or blue cheese flavour. A large number of flavourings may be substituted for the enzyme modified cheese flavours, with the flavouring selected by those skilled in the art based on the desired attributes of the product of this invention. For example, yeast extracts may be incorporated as an additive ingredient to impart a flavour profile typically described as savory and/or umami. Taste of the dairy food gel product may also be regulated through the addition of plant substances e.g. herbs, spices and spice blends. At least according to some embodiments, it will be appreciated that the flavourings do not comprise cheese products, for example cheddar cheese.

The fat in the dairy food gel product is fat retained from the starting milk present in the comprised MPC, in addition to any fats that have been added to the retentate or fermentate during production of the MPC or dairy food gel ingredient comprising an MPC, or as part of the one or more ingredients from which the dairy food gel product is produced. Non-limiting examples of fats include cream, plastic cream, butter, anhydrous milk fat, edible oils, animal and/or vegetable fats, and/or other dairy fat. Fat may be incorporated as an additive ingredient for a variety of reasons, but primarily to regulate taste, texture, and/or nutritional content. Alternatively, additional fat may not be incorporated as an additive ingredient, e.g., certain low fat cheese-like dairy food gel products do not require the addition of extra fat.

Protein may be incorporated into the dairy food gel product in order to regulate nutritional content and/or texture. Additive ingredients that can be added for this purpose include, but are not limited to protein solutions or powders of non-fermented milk protein concentrates and micellar casein, caseins and caseinates, whey protein concentrates and isolates, soy protein isolates, pea protein isolates, and chickpea protein. Non-dairy protein isolates can also be incorporated into the dairy food gel product, to alter the texture of the cheese and/or to change the size, colour, or integrity of the blisters that are formed when the dairy food gel product is baked on a pizza, as well as other characteristics. Non-limiting examples of suitable non-dairy protein isolates include soy protein (sometimes called “soy powder”), gelatin, wheat germ, corn germ, gluten, and egg solids. A non-dairy protein isolate, if added, is typically added as a powdered solid. In one example, any dairy protein present is provided by one or more MPCs according to any embodiments or examples as described herein.

Sweeteners, such as artificial sweeteners, or sugar may be added in order to regulate the taste of the finished dairy food gel product. Non-limiting examples of sweeteners include natural sweeteners, such as honey, maple syrup, and agave nectar, and artificial sweeteners, such as aspartame, saccharin, and sucralose. Other non-limiting examples include stevia, erythritol, xylitol, maltitol, sorbitol, lactitol, isomalt, trehalose, high fructose corn syrup, corn syrup, molasses, brown sugar, and powdered sugar.

Non-limiting examples of stabilizers which can be employed in the present invention include hydrophilic colloidal stabilizers commonly known in the art such as gum arabic, gelatin, xanthan, locust bean, propylene glycol alginate, polysaccharides (e.g. carrageenan), and pectin, as well as anionic polymers derived from cellulose (e.g., carboxymethylcellulose), which are water soluble and tolerant of low pH's. These stabilisers are typically plant-derived and are lower cost than other protein and fat sources, and so are effective at maintaining texture while reducing total solids content. Stabilisers can be effectively used to vary the texture of cheese foods. For example, carrageenan can be added to improve the spreadability of a dairy food gel product.

Dietary supplements or vitamins (e.g. vitamin C) may be incorporated in order to impart additional nutritional benefit to the finished dairy food gel product. Prebiotics, probiotics, or postbiotics may be incorporated in order to promote health. For example, one or several Lactobacillus or Streptococcus strain(s) of probiotics may be included to e.g. facilitate healthy oral and/or intestinal flora.

Any thickener acceptable for use in food may be incorporated to add texture and/or improve mouthfeel. Non-limiting examples of thickeners include agar, arrowroot, carrageenan, cellulose gum, cornstarch, gelatin, guar gum, konjac gum, locust bean gum, maltodextrin, modified food starch, pectin, potato starch, rice flour, sorbitol, tapioca starch, vegetable gums, wheat flour, xanthan gum, and zein.

Any emulsifier acceptable for use in food may be incorporated to add and/or stabilize texture and/or mouthfeel. Non-limiting examples of emulsifiers include lecithin, mono- and diglycerides, polysorbates, sorbitan esters, glycerol esters, stearoyl lactylates, propylene glycol esters, sucrose esters, polyglycerol esters, carrageenan, agar, alginates, xanthan gum, gum arabic, cellulose gum, and carboxymethyl cellulose.

Other additive ingredients that may be incorporated include water, oils, cheese, preservatives, flow agents, humectants, antioxidant, firming agents, milk protein concentrate, and dairy food gel ingredients comprising a milk protein concentrate. In some embodiments, any additives if present do not comprise cheese, for example cheddar cheese.

If present, the one or more additive ingredients (separately or combined) may be provided in an amount (based on wt % of total ingredients, excluding water) of less than about 50, 45, 40, 35, 30, 25, 20, 15, 10, 9, 8, 7, 6, 5, 4, 3, 2, or 1. The one or more additive ingredients may be provided in any range between any two of the previous amounts. For example, if present any additional dairy ingredients may be provided in an amount of less than about 10, 9, 8, 7, 6, 5, 4, 3, 2, or 1, or any range between any two of those amounts (e.g. between about 1 and 10 or between about 1 and 5). Any of the one or more MPC (or ingredient comprising MPC) may therefore be provided in an amount (based on wt % of total ingredients including any additives if present, excluding water) of at least about 50, 55, 60, 65, 70, 75, 80, 85, 90, 95, 96, 97, 98, or 99, or in any range therebetween.

### Processes for Preparing Dairy Food Gel Ingredients

The dairy food gel ingredient may be prepared by blending the MPC ingredient with one or more additive ingredients. The MPC ingredient and one or more additive ingredients may be provided according to any aspects, embodiments or examples thereof as described herein.

The process for preparing a dairy food gel ingredient may include some or all of the steps, including optionally, any optional steps, of the process for preparing an MPC ingredient according to any embodiments or examples thereof as described herein. For example, the MPC ingredient used to produce the dairy food gel ingredient may be selected from any one or more of a cMPC, a fMPC, and a fcMPC, according to any embodiments or examples thereof as described further below and herein. At least according to some embodiments, the fermented and/or calcium reduced MPCs can provide further advantages regarding processability into suitable ingredients and use in the present process, and/or enabling suitable flavours and textures for directly obtaining edible dairy food gel products.

For example, a method of producing a dairy food gel ingredient comprising a milk protein concentrate (MPC) suitable for producing a dairy food gel product may comprise:
subjecting concentrated milk, reconstituted dry milk concentrate or an aqueous solution comprising an MPC to a divalent ion (e.g. calcium) reduction or exchange step to obtain a divalent ion reduced retentate (e.g. calcium reduced retentate) having a calcium content, monovalent cation to divalent cation ratio, or cationic balance, according to any embodiments or examples thereof as described herein (e.g. cMPC);
subjecting the retentate to fermentation to produce a fermentate;
concentrating the fermentate to produce an MPC ingredient (e.g. fcMPC);
recovering the MPC ingredient;
optionally blending the MPC ingredient with one or more additive ingredients to produce a dairy food gel ingredient; and
recovering said dairy food gel ingredient.

Additive ingredients may be added at any suitable step in the process as would be appreciated by a person skilled in the art. The flexibility of allowing any combination of additives to be added at any step in the process allows the final composition of the cheese to be precisely controlled, including the functionality characteristics. For example, such additive ingredients may be added following the concentration that occurs after enzymatic modification, either before or after optional drying of the modified MPC. Following or during the addition of the additive ingredients, the mixture is blended to homogeneity.

In one example, one or more additive ingredients may be added following evaporation and/or spray draying of the MPC ingredient. In one example, fat, cream, acidulents or flavourings in powdered form are added and blended with the powdered MPC ingredient.

In some embodiments, the MPC ingredient is blended with at least 1, 2, 3, 4, 5, 6, 7, 8, 9, or 10 additive ingredients. In some embodiments, the MPC ingredient is blended with less than 10, 9, 8, 7, 6, 5, 4, 3, 2 additive ingredients. In some embodiments, the MPC ingredient is blended with a number of additive ingredients in a range provided by any of the previously described upper and/or lower amounts, for example, the MPC ingredient is blended with between 1 and 10, 1 to 5, or 2 to 4 additive ingredients. If present, the one or more additive ingredients may be provided at an amount (based on wt % of total ingredient formulation) of less than about 50, 45, 40, 35, 30, 25, 20, 15, 10, 9, 8, 7, 6, 5, 4, 3, 2, or 1, or in any range therebetween.

The concentrated dairy food gel ingredient comprising an MPC, either as a solution or powder, may be used directly in the formulation and formation of dairy food gel products as described according to any aspect, embodiment or example herein.

### Milk Protein Concentrate (MPC) Ingredient

The present disclosure also provides a milk protein concentrate (MPC) ingredient, which may be used in any one or more of the methods or processes as described herein.

In some embodiments, the MPC ingredient comprises any one or more of:
a milk protein content of between about 20 to 95% w/w;
a fat content of between about 0 to 60% w/w;
a carbohydrate content of between about 0 and 10% w/w;
a water content of between about 10 to 90% w/w;
a total solids content greater than 15% w/w;
a calcium content of between 20 to 400 mmol/kg;
a monovalent cation content of between 200 to 1000 mmol/kg;
a divalent cation content of between 20 to 100 mmol/kg;
a monovalent to divalent cation ratio of between about 5 to 30;
a cationic balance of between 10 to 60;
a pH of between about 4.5 to 8, for example 5 to 7.

In some embodiments, the MPC ingredient comprises:
a fat content of between 0 to 60% w/w;
a calcium content of between 20 to 400 mmol/kg; and
a cationic balance of between 10 to 60.

In some embodiments, the MPC ingredient comprises:
a fat content of between 0 to 60% w/w;
a calcium content of between 20 to 400 mmol/kg;
a monovalent to divalent cation ratio of between about 5 to 25; and
a cationic balance of between 10 to 60.

In some embodiments, the MPC ingredient comprises:
a milk protein content of between about 20 to 95% w/w;
a fat content of between 0 to 60% w/w;
a calcium content of between 20 to 400 mmol/kg
a monovalent to divalent cation ratio of between about 5 to 30; and
a cationic balance of between 10 to 60.

In some embodiments, the MPC ingredient comprises:
a cationic balance of between 10 and 60; and
a monovalent to divalent cation ratio between about 5 and 30.

In some embodiments, the MPC ingredient comprises:
a cationic balance of between 10 and 60;
a monovalent to divalent cation ratio between about 5 and 30; and
a calcium to protein ratio (in g/kg) between about 0.1 and 15.

In some embodiments, the MPC ingredient comprises:
a cationic balance of between 10 and 60;
a calcium to protein ratio (in g/kg) between about 0.1 and 15.

In some embodiments, the MPC ingredient comprises:
a monovalent to divalent cation ratio between about 5 and 30; and
a calcium to protein ratio (in g/kg) between about 0.1 and 15.

In some embodiments, the MPC ingredient comprises:
a milk protein content of between about 20 to 95% w/w; and
a calcium to protein ratio (in g/kg) between about 0.1 and 15.

In some embodiments, the MPC ingredient comprises:
a cationic balance of between 10 and 60;
a monovalent to divalent cation ratio between about 5 and 30; and a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, or 15.

In some embodiments, the MPC ingredient comprises:
a cationic balance of between 10 and 60;
a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, or 15.

In some embodiments, the MPC ingredient comprises:
a monovalent to divalent cation ratio between about 5 and 30; and
a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, or 15.

In some embodiments, the MPC ingredient comprises:
a milk protein content of between about 20 to 95% w/w; and
a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, or 15.

In some embodiments, the MPC ingredient comprises:
a casein to whey ratio (w/w) of less than about 90:10, 85:15, or 80:20; and
a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, or 15.

In some embodiments, the MPC ingredient comprises:
a casein to whey ratio (w/w) between about 70:30 and 90:10; and
a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, or 15.

In some embodiments, the MPC ingredient comprises:
a casein to whey ratio (w/w) between about 70:30 and 85:15; and
a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, or 15.

In some embodiments, the MPC ingredient comprises:
a casein to whey ratio (w/w) between about 80:20 and 85:15; and
a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, or 15.

In some embodiments, the MPC ingredient comprises:
a casein to whey ratio (w/w) between about 75:25 to about 85:15, for example, between about 80:20 and 85:15; and
a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, or 15.

In some embodiments, the MPC ingredient comprises:
a casein to whey ratio (w/w) between about 75:25 to about 85:15, for example, between about 80:20 and 85:15; and
a cationic balance of between 10 and 60.

In some embodiments, the MPC ingredient comprises:
a cationic balance of between 10 and 60;
a milk protein content of between about 20 to 95% w/w;
a calcium content of between 20 to 400 mmol/kg; and
a pH of between about 4.5 to 8, for example 5 to 7.

In some embodiments, the MPC ingredient is prepared by a method or process according to any aspect, embodiment, or examples as described herein.

In some embodiments, the MPC ingredient is prepared by a process comprising one or more of: fermentation, divalent ion reduction (e.g. calcium-reduction, and enzymatic treatment, each of which can be provided according to any embodiments or examples thereof as described herein. In some examples, the MPC ingredient is selected from any one or more of a cMPC, a fMPC, and a fcMPC, according to any embodiments or examples thereof as described further below and herein. In one example, the MPC ingredient is a fermented and calcium-reduced MPC (fcMPC) ingredient, which can be provided according to any embodiments or examples thereof as described herein.

In some embodiments, the MPC ingredient is a fermented MPC (fMPC) ingredient. It will be appreciated that a fermented MPC ingredient is an MPC ingredient prepared by a method or process comprising a fermentation step. In some examples, the fermentation step comprises the use of a lactic acid bacteria to convert at least some of the lactose in the milk, or reconstituted MPC from which the fermented MPC is derived, into lactic acid.

In some embodiments, the MPC ingredient is a divalent ion reduced MPC, such as a calcium-reduced MPC (cMPC) ingredient. It will be understood that a calcium-reduced MPC ingredient is an MPC ingredient prepared by a method or process comprising a calcium-reduction step. A calcium-reduced MPC ingredient contains less calcium per kg of total protein, relative to the amount of calcium per kg of total protein typically found in an equivalent MPC produced by the filtration and/or concentration of milk at the typical pH of fresh milk, i.e. 6.6 to 6.8. At least according to some embodiments, the calcium reduced MPCs can provide further advantages regarding processability into suitable ingredients and use in the present process, and/or enabling suitable flavours and textures for directly obtaining edible dairy food gel products.

In some embodiments, the MPC ingredient is an enzymatically reduced MPC ingredient (eMPC). In some embodiments the MPC ingredient is a rennet MPC (rMPC) ingredient. It will be understood that an enzymatically reduced MPC, such as a rennet MPC ingredient, is an MPC ingredient that contains cleaved κ-casein, and/or is prepared by a method or process comprising an enzymatic modification step using an enzyme capable of cleaving κ-casein such as rennet. Rennet or other κ-casein cleaving enzymes may be animal or non-animal derived, non-limiting examples of which include papain, ficin, bromelain, bovine pepsin, porcine pepsin, chicken pepsin and the acid proteinases of Rhizomucor miehei, R. pusillus and Cryphonectria parasitica.

### MPC-Milk Protein Content

It will be appreciated that an MPC ingredient may be described in terms of its ‘milk protein content’ (or simply ‘protein content’), which refers to the total amount of protein in the MPC ingredient, expressed as a weight percentage relative to the total weight of all components of the MPC ingredient. In some embodiments, the MPC ingredient has a milk protein content (in % w/w) greater than about 1, 5, 10, 15, 20, 25, 30, 35, 40, 45, 50, 55, 60, 65, 70, 75, 80, 85, 90, or 95. In some embodiments, the MPC ingredient has a milk protein content (in % w/w) less than about 95, 90, 85, 80, 75, 70, 65, 60, 55, 50, 45, 40, 35, 30, 25, 20, 15, 10, 5, or 1. In some embodiments, the MPC ingredient has a milk protein content in a range provided by any two of the previously described upper and/or lower amounts, for example, wherein the milk protein content (in % w/w) is between about 1 and 95, 5 and 80, 20 and 95, 10 and 70, 20 and 60, 30 and 50, or 70 and 90. It will be appreciated that a person skilled in the art may desire to produce an MPC ingredient that has a particular protein content (or a protein content in a particular range) such that the MPC ingredient may be used to produce a dairy food gel product having a particular protein content that accords with a dietary need or preference of a consumer or group of consumers.

The MPC ingredient may comprise a variety of milk proteins, non-limiting examples of which include caseins (e.g. α-casein, β-casein, and κ-casein), whey proteins (e.g. α-lactalbumin, β-lactoglobulin), immunoglobulins, and lactoferrin. Proteins may be present in their native or denatured forms. Denaturation may be performed in order to impart certain properties to the dairy food gel products produced from the MPC. For example, denatured whey proteins can enhance tenderness of the dairy food gel product formed from the MPC.

### MPC—Fat Content

It will be appreciated that an MPC ingredient may be described in terms of its ‘fat content’, which refers to the total amount of fat in the MPC ingredient, expressed as a weight percentage relative to the total weight of all components of the MPC ingredient. In some embodiments, the MPC ingredient has a fat content (in % w/w) greater than about 0, 1, 3, 5, 10, 15, 20, 25, 30, 35, 40, 45, 50, 55, 60, 65, 70, 75, 80, 85, 90, or 95. In some embodiments, the MPC ingredient has a fat content (in % w/w) less than about 95, 90, 85, 80, 75, 70, 65, 60, 55, 50, 45, 40, 35, 30, 25, 20, 15, 10, 5, 3 or 1. In some embodiments, the MPC ingredient has a fat content in a range provided by any two of the previously described upper and/or lower amounts, for example, wherein the fat content (in % w/w) is between about 1 and 95, 0 and 60, 1 and 50, 1 to 60, 40 and 60, 50 and 60, 45 and 65, 40 and 70, 1 and 5, or 1 and 3. It will be appreciated that a person skilled in the art may desire to produce an MPC ingredient that has a particular fat content (or a fat content in a particular range) such that the MPC ingredient may be used to produce a dairy food gel product having a particular fat content that accords with a dietary need or preference of a consumer or group of consumers.

### MPC—Fat to Protein Ratio

It will be appreciated that an MPC ingredient may be described in terms of its ‘fat-to-protein ratio, which refers to the ratio of the total amount of fat to the total amount of protein in the MPC ingredient. In some embodiments, the MPC ingredient has a fat-to-protein ratio greater than about 0.1:1, 0.5:1, 1:1, 1.5:1, 2:1, 3:1 or 5:1. In some embodiments, the MPC ingredient has a fat-to-protein ratio less than about 5:1, 3:1, 2:1, 1.5:1, 1:1, 0.5:1, or 0.1:1. In some embodiments, the MPC ingredient has a fat-to-protein ratio in a range provided by any two of the previously described upper and/or lower amounts, for example, wherein the fat-to-protein ratio is between about 0.1:1 and 5:1, 0.5:1 to 3:1, or 1:1 to 2:1.

### MPC—Carbohydrate Content

It will be appreciated that an MPC ingredient may be described in terms of its ‘carbohydrate content’, which refers to the total amount of carbohydrate in the MPC ingredient, expressed as a weight percentage relative to the total weight of all components of the MPC ingredient. In some embodiments, the MPC ingredient has a carbohydrate content (in % w/w) greater than about 0, 1, 2, 3, 4, 5, 6, 7, 8, 9, 10, 11, 12, 13, 14, 15, 16, 17, 18, 19, or 20. In some embodiments, the MPC ingredient has a carbohydrate content (in % w/w) less than about 20, 19, 18, 17, 16, 15, 14, 13, 12, 11, 10, 9, 8, 7, 6, 5, 4, 3, 2, or 1. In some embodiments, the MPC ingredient has a carbohydrate content in a range provided by any two of the previously described upper and/or lower amounts, for example, wherein the carbohydrate content (in % w/w) is between about 0 and 20, 1 and 10, or 1 and 5. It will be appreciated that a person skilled in the art may desire to produce an MPC ingredient that has a particular carbohydrate content (or a carbohydrate content in a particular range) such that the MPC ingredient may be used to produce a dairy food gel product having a particular carbohydrate content that accords with a dietary need or preference of a consumer or group of consumers.

### MPC—Water Content

It will be appreciated that an MPC ingredient may be described in terms of its ‘water content’, which refers to the total amount of water in the MPC ingredient, expressed as a weight percentage relative to the total weight of all components of the MPC ingredient. In some embodiments, the MPC ingredient has a water content (in % w/w) greater than about 1, 2, 3, 4, 5, 6, 7, 8, 9, 10, 15, 20, 25, 30, 35, 40, 45, 50, 55, 60, 65, 75, 80, 85, 90, or 95. In some embodiments, the MPC ingredient has a water content (in % w/w) less than about 100, 95, 90, 85, 80, 75, 70, 65, 60, 55, 50, 45, 40, 35, 30, 25, 20, 15, 10, 9, 8, 7, 6, 5, 4, 3, 2 or 1. In some embodiments, the MPC ingredient has a water content in a range provided by any two of the previously described upper and/or lower amounts, for example, wherein the water content (in % w/w) is between about 5 and 95, 10 to 90, 40 and 60, 1 and 10, 1 and 8, or 1 and 5. The water content of an MPC ingredient will in some cases, dictate the form of the MPC ingredient. For example, a powdered MPC will typically have a water content less than about 10% w/w (for example less about 5% w/w, or less about 4% w/w, or less about 3% w/w, or less than about 2% w/w), a paste MPC ingredient will have a water content greater than about 20% w/w or between about 20% w/w and about 30% w/w, and a concentrate MPC ingredient will have a water content between about 30% w/w and 70% w/w.

### MPC—Total Solids

It will be appreciated that an MPC ingredient may be described in terms of its ‘total solids content’, which refers to the total amount of solids in the MPC ingredient, expressed as a weight percentage relative to the total weight of all components of the MPC ingredient. In some embodiments, the MPC ingredient has a total solids content (in % w/w) greater than about 1, 5, 10, 15, 20, 25, 30, 35, 40, 45, 50, 55, 60, 65, 70, 75, 80, 85, 90, 95, 96, 97, 98 or 99. In some embodiments, the total solids content may be in a range provided by any two of the previously described amounts, such as 1 to 99, 25 to 80, 20 to 99, 80 to 99, 90 to 99 or 95 to 99.

### MPC—Form

In some embodiments, the MPC ingredient may be provided as a solid, powder, an extrudate, a paste, a suspension, a dispersion, an emulsion, a liquid, a gel, a concentrate, and a foam. In some examples, the MPC ingredient is provided as a powder, an extrudate, and a paste. It will be understood that an MPC ingredient in any of these forms may in some examples be frozen, and accordingly may be described as such e.g. a frozen paste, a frozen liquid, a frozen gel, etc.

### MPC—Mineral Content

It will be appreciated that an MPC ingredient may be described in terms of its ‘calcium content’, which refers to the total amount of calcium in the MPC ingredient, expressed as the amount of calcium (e.g. in mmol) relative to the total weight (e.g. in kg) of all components of the MPC ingredient. In some embodiments, the MPC ingredient has a calcium content (in mmol/kg) greater than about 1, 10, 20, 50, 100, 200, 300, 400, 500, 1000, 2000, or 5000. In some embodiments, the MPC ingredient has a calcium content (in mmol/kg) less than about 5000, 2000, 1000, 500, 400, 300, 200, 100, 50, 20, 10, or 1. In some embodiments, the MPC ingredient has a calcium content (in mmol/kg) in a range provided by any of the previously described upper and/or lower amounts, for example, the calcium content (in mmol/kg) is between about 1 to 5000, 1 to 1000, 1 to 200, 20 to 400, or 20 to 100. At least according to some embodiments, the calcium reduced MPCs can provide further advantages regarding processability into suitable ingredients and use in the present process, and/or enabling suitable flavours and textures for directly obtaining edible dairy food gel products.

It will be appreciated than an MPC ingredient may be described in terms of ‘calcium depletion’. Calcium depletion is described as a percentage of the amount of calcium (in mmol) per kg of total protein on a dry basis, relative to the amount of calcium (in mmol) per of kg of total protein typically found in equivalent MPC solutions produced by the filtration of milk at the typical pH of fresh milk, ie 6.6 to 6.8. In some embodiments, the MPC ingredient has a calcium depletion (in %) of greater than about 1, 5, 10, 20, 30, 40, 50, 60, 70, 80, 90, 95. In some embodiments, the MPC ingredient has a calcium depletion (in %) of less than about 100, 95, 90, 80, 70, 60, 50, 40, 30, 20, 10, 5, or 1. In some embodiments, the MPC ingredient has a calcium depletion (in %) in a range provided by any of the previous described upper and/or lower amounts, for example, the calcium depletion (in %) is between about 1 to 100, 60 to 95, 70 to 90, 70 to 95, or 80 to 95.

It will be appreciated that an MPC ingredient may be described in terms of its ‘monovalent cation content’, which refers to the total amount of monovalent ions in the MPC ingredient, expressed as the amount monovalent cations (e.g. in mmol) relative to the total weight (e.g. in kg) of all components of the MPC ingredient. Suitable monovalent cations include, but are not limited to, Na⁺, K⁺, and combinations thereof. In some embodiments, the MPC ingredient has a monovalent cation content (in mmol/kg) greater than about 1, 50, 100, 200, 500, 600, 700, 800, 900, 1000, 1200, 1400, 1600, 1800, 2000, 3000, 4000, or 5000. In some embodiments, the MPC ingredient has a monovalent cation content (in mmol/kg) less than about 5000, 4000, 3000, 2000, 1800, 1600, 1400, 1200, 1000, 900, 800, 700, 600, 500, 400, 300, 200, 100, 50, or 1. In some embodiments, the MPC ingredient has a monovalent cation content (in mmol/kg) in a range provided by any of the previously described upper and/or lower amounts, for example, the monovalent cation content (in mmol/kg) is between about 1 to 5000, 100 to 2000, 100 to 1000, 400 to 1600, 400 to 1200, or 200 to 1000.

It will be appreciated that an MPC ingredient may be described in terms of its ‘divalent cation content’, which refers to the total amount of divalent cations in the MPC ingredient, expressed as the amount divalent cations (e.g. in mmol) relative to the total weight (e.g. in kg) of all components of the MPC ingredient. Suitable divalent cations include, but are not limited to, Ca²⁺, Mg²⁺, Mn²⁺, Zn²⁺ and combinations thereof. In some embodiments, the MPC ingredient has a divalent cation content (in mmol/kg) greater than about 1, 10, 20, 50, 100, 200, 300, 500, 1000, 2000, 3000, 4000, or 5000. In some embodiments, the MPC ingredient has a divalent cation content (in mmol/kg) less than about 5000, 4000, 3000, 2000, 1000, 500, 300, 200, 100, 50, 20, 10, or 1. In some embodiments, the MPC ingredient has a divalent cation content (in mmol/kg) in a range provided by any of the previously described upper and/or lower amounts, for example, the divalent cation content (in mmol/kg) is between about 1 to 5000, 1 to 1000, 1 to 200, or 20 to 100.

It will be appreciated that an MPC ingredient may be described in terms of its ‘monovalent to divalent cation ratio’, which refers to the total amount of monovalent cations in the MPC ingredient relative to the amount of divalent ions in the MPC ingredient, expressed as a ratio (e.g. in mmol/mmol). In some embodiments the MPC ingredient has a monovalent to divalent cation ratio (in mmol/mmol) greater than about 0, 1, 2, 3, 4, 5, 6, 7, 8, 9, 10, 11, 12, 13, 14, 15, 16, 17, 18, 19, 20, 25, 30, 40, 50. In some embodiments the MPC ingredient has a monovalent to divalent cation ratio (in mmol/mmol) less than about 50, 40, 30, 25, 20, 19, 18, 17, 16, 15, 14, 13, 12, 11, 10, 9, 8, 7, 6, 5, 4, 3, 2 or 1. In some embodiments the MPC ingredient has a monovalent to divalent cation ratio (in mmol/mmol) in a range provided by any of the previously described upper and/or lower amounts, for example, the monovalent to divalent cation ratio (in mmol/mmol) is between about 1 to 50, 2 to 30, 5 to 30, or 5 to 25.

It will be appreciated that an MPC ingredient may be described in terms of its ‘cationic balance’. ‘Cationic balance’ may be expressed as a ratio (for example in mmol·kg/mmol or mg·kg/mg), and refers to the ratio of: (1) the monovalent to divalent cation ratio of the MPC ingredient; relative to (2) the protein content of the MPC ingredient. The protein content of the MPC ingredient will be understood to refer to the weight of the protein component of the MPC ingredient, relative to the total weight of the MPC ingredient (which may, for example, be expressed as kg/kg). In some embodiments, the MPC ingredient has a cationic balance (in mmol·kg/mmol) greater than about 0.5, 1, 5, 15, 10, 20, 30, 40, 50, 60, 70, 80, 90, 100, 200, or 500. In some embodiments, the MPC ingredient has a cationic balance (in mmol·kg/mmol) less than about 500, 200, 100, 90, 80, 70, 60, 50, 40, 30, 20, 15, 10, 5, 1, or 0.5. In some embodiments, the MPC ingredient has a cationic balance (in mmol·kg/mmol) in a range provided by any of the previously described upper and/or lower amounts, for example, the cationic balance (in mmol·kg/mmol) of between about 0.5 and 500, 1 and 200, 10 and 150, 10 and 100, 10 and 70. It will be appreciated that the MPC ingredient may also be described in terms of the amount of calcium relative to the amount of protein in the MPC ingredient. In other words, an MPC ingredient may be described in terms of its ‘calcium to protein ratio’, which refers to the total amount of calcium (e.g. in g, or alternatively mmol) in the MPC ingredient relative to the amount of protein (e.g. in kilograms) in the MPC ingredient, expressed as a ratio (e.g. in terms of g/kg, or alternatively, mmol/kg). In some embodiments the MPC ingredient has a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, or 15. In some embodiments the MPC ingredient has a calcium to protein ratio (in g/kg) between about 0.1 and about 15, between about 0.5 and about 15, between about 1 and about 15, between about 1.5 and about 15, between about 0.1 and about 10, between about 0.5 and about 10, between about 1 and about 10, between about 1.5 and about 10, between about 0.1 and about 8, between about 0.5 and about 8, between about 1 and about 8, between about 1.5 and about 8.

### MPC—pH

It will be appreciated that an MPC ingredient may be described in terms of its ‘pH’. In some embodiments, the MPC ingredient has a pH greater than about 3, 3.5, 4, 4.5, 5, 5.5, 6, 6.5, 7, 7.5, 8, 8.5, 9, 9.5, or 10. In some embodiments, the MPC ingredient has a pH less than about 10, 9.5, 9, 8.5, 8, 7.5, 7, 6.5, 6, 5.5, 5, 4.5, 4, 3.5, or 3. In some embodiments, the MPC ingredient has a pH in a range provided by any of the previously described upper and/or lower amounts, for example, the MPC ingredient is between about 3 to 10, 4 to 8, 4.5 to 8, or 5 to 7.

### MPC—Casein to Whey Ratio

It will be appreciated that an MPC ingredient may be described in terms of its casein to whey ratio. In some embodiments, the MPC ingredient has a casein to whey ratio approximately that of milk. In some embodiments, the MPC ingredient has a casein to whey ratio approximately that of whole milk. In some embodiments, the MPC ingredient has a casein to whey ratio between about 70:30 to about 90:10, 71:29 to about 89:11, between about 72:28 to about 88:12, between about 73:27 to about 87:13, between about 74:26 to about 86:14, between about 75:25 to about 85:15, between about 76:24 to about 84:16, between about 77:23 to about 83:17, between about 78:22 to about 82:18, between about 79:21 to about 81:19, or between about 80:20 and 85:15. In some embodiments, the MPC ingredient has a casein to whey ratio (w/w) of about 80:20.

### MPC Preparation

The present disclosure also provides methods of preparing a milk protein concentrate (MPC) ingredient suitable for producing a dairy food gel product.

In some embodiments, the MPC ingredient is prepared by methods comprising modifying an MPC or ingredient source comprising an MPC by any one or more of:
fermentation, divalent ion reduction (e.g. calcium reduction using mineral ion exchange), and enzymatic reduction (e.g. renetting). In some embodiments, the MPC ingredient is prepared by methods comprising modifying an MPC or ingredient source comprising an MPC by fermentation and divalent ion reduction (e.g. calcium reduction using mineral ion exchange) to produce an fcMPC ingredient.

In some examples, the method may comprise:
subjecting concentrated milk, reconstituted dry milk concentrate or an aqueous solution comprising an MPC to a divalent ion (e.g. calcium) reduction or exchange step to obtain a divalent ion reduced retentate (e.g. calcium reduced retentate) having a calcium content, monovalent cation to divalent cation ratio, or cationic balance, according to any embodiments or examples thereof as described herein;
subjecting the retentate to fermentation to produce a fermentate;
concentrating the fermentate to produce an MPC ingredient; and
recovering the MPC ingredient.

In some examples, the divalent ion reduction or exchange step is a calcium ion reduction or exchange step. In some examples, the exchange step comprises a mineral ion exchange using a food approved mineral ion exchanger.

In some examples, the method of producing a modified MPC ingredient further comprises the step of subjecting the fermentate to further enzymatic modification.

In some examples, the further enzymatic modification comprises a step of coagulation using rennet.

In some examples, the method of producing a modified MPC ingredient further comprises a step of dewatering and drying said MPC ingredient into a powder.

### Pasteurisation and Separation

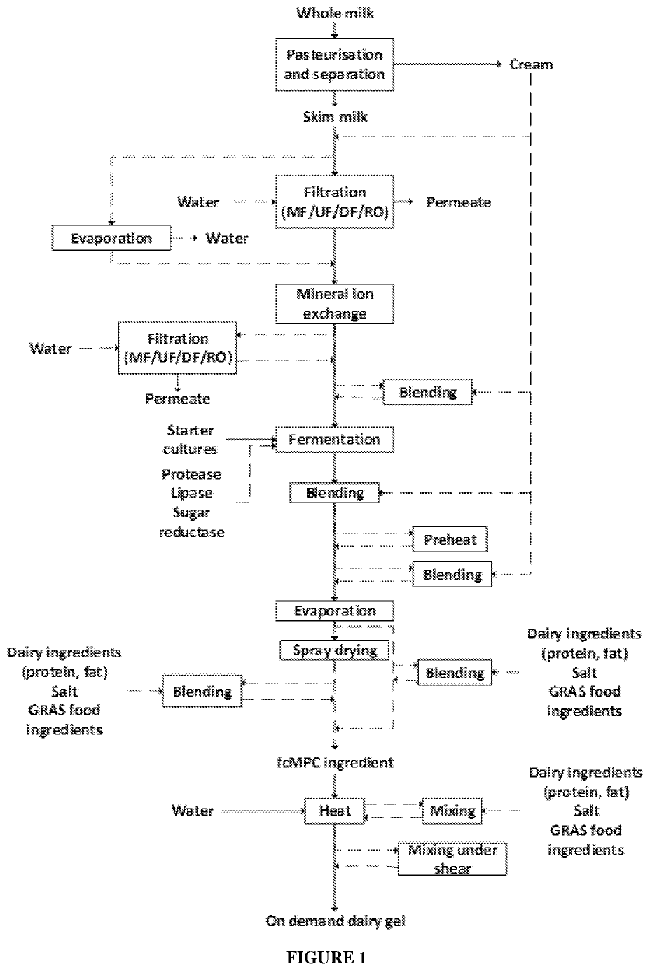

The preparation of the modified MPC ingredient may be more fully understood by having reference to FIG. 1, which is a flow diagram of a process relating to an aspect of the invention. FIG. 1 illustrates the steps that are either required or optional to produce a modified MPC ingredient, in addition to those that are either required or optional to produce a dairy food gel product.

For preparation of the MPC, the preferred starting material is milk. As used herein, “Milk” is the lacteal secretion obtained from mammals, preferably cattle, and more preferably bovine species. The term is meant to include lacteal secretions with the composition adjusted by means of either removing components, such as fat, or adding components, such as protein, fat, carbohydrate, etc. Furthermore, the term is meant to include acidified milk, cultured milk, concentrated milk, condensed milk, evaporated milk, skim milk, and reconstituted dry milk products. Milk may be sourced from fresh supplies or reconstituted from skim, buttermilk or whole milk powders, including retentate powders, or combinations thereof with a potable solvent, such as water or milk. A reconstituted MPC may be also used as a starting material, in order to produce a modified MPC ingredient.

The fat content of the milk may be adjusted by various methods known in the art involving the incorporation and/or extraction of cream and/or fat. For example, the fat content of whole milk may be adjusted as desired using separation (e.g. centrifugation) to remove fat as cream, or by using standardization to reduce or enrich the fat content by adding the appropriate cream or skim milk products. Separation and/or standardization can produce a starting material ranging from skim milk to fat enriched whole milk. The milk may be pasteurized and cooled as required using standard procedures. If necessary, the size of the fat globules in the milk can be reduced by homogenization.

### Filtration

Numerous filtration procedures may be used to remove desired portions of the water, lactose, milk salts, and (optionally) some or all of the whey proteins from the milk. Non-limiting examples of filtration procedures which may be used for the fractionating of the milk components include (continuous) membrane filtration, ultrafiltration, nanofiltration, diafiltration, cross-flow filtration, centrifugal filtration, vacuum filtration, depth filtration, and loose reverse osmosis. The prepared milk may be fractionated to produce an MPC solution by ultrafiltration (UF) using a suitable membrane system capable of achieving a volume concentration factor (VCF volume of milk volume of retentate) of between 2 to 8 times. A preferred UF system is equipped with a membrane capable of retaining compounds with a molecular weight greater than 10,000 to 30,000, that is used to produce a UF retentate with a VCF between 3 to 6 times. Protein concentration may be enhanced during UF by diafiltration the process of adding water during UF to increase the removal of lactose and dissolved milk salts and reduce retentate viscosity. A suitable UF/DF system will produce retentates with a total solids (TS) content of about 14% to 50%. The preferred UF/DF system produces retentates from skim milk with 14% to 30% TS, and retentates from whole milk with 35% to 45% TS. A preferred UF/DF system can produce UF retentates containing essentially all of the caseins and whey proteins initially present in the milk feed stream. Use of filtration in the manufacture of MPCs is well documented.

Optionally, pre, or post filtration, the casein and soluble proteins may be treated to control or modify their concentrations. In some examples, ion exchange, chromatography, pH and temperature treatments may be used to remove or deplete selected proteins or protein fractions. Optionally, proteins may be added. Such proteins may be either dairy or non-dairy.

Optionally, pre, or post filtration, the casein and soluble proteins may be treated to control or modify their interactions. In one embodiment, the soluble proteins may become partially or fully attached or chemically linked to the casein. Such treatments may involve thermal, chemical (including pH), physio-chemical (including pressure) or enzymatic modifications.

Alternatively, the milk need not undergo filtration, and may be concentrated in a single evaporation step.

### Mineral Ion Adjustment

Following filtration, the mineral ion content (i.e. mineral cation content) can be adjusted in a mineral ion adjustment step. A person skilled in the art will appreciate that a variety of methods for adjusting the mineral content, in particular the calcium content, during preparation and/or modification of an MPC. Treatment conditions according to this disclosure that alter the calcium content can also effect corresponding changes to all the divalent cations present. Throughout the description of the present invention, calcium is used as the reference mineral for comparing divalent cations in the modified process streams and products. It should be noted that levels of other minerals, e.g. magnesium, will also be modified.

For example, Moran et al (U.S. Pat. No. 6,183,804, the entirety of which is incorporated by reference) teaches that the calcium content of MPC can be adjusted (i.e. lowered) by acidification of the milk prior to ultrafiltration. Also taught is that in addition, if desired, sodium chloride can be added to the milk prior to ultrafiltration in order to lower the calcium content. Using these techniques, there is a practical limit to the proportion of the calcium that can be removed during the ultrafiltration of milk because of factors such as protein precipitation, retentate viscosity and limits to the extent of diafiltration. Additionally, ultrafiltration flux rates may be hindered and contamination of the permeate by the added salt or acid can reduce its value. Typically the practical removal limit using membrane techniques on a commercial plant would be about 20% of the calcium. The pH of the milk may be adjusted within the range of 3.0 to 9.5 by the addition of edible acid and/or alkali. The extent of pH adjustment promotes the dissolution of the divalent ions in the casein, allowing these minerals to migrate to the milk serum and to be removed from the milk during filtration. A preferred procedure is to reduce the pH of milk at a temperature ≤18° C. by the addition of edible acids to enhance the dissolution of divalent mineral complexes present in the casein. Alternatively, enhanced removal of the divalent ions may be achieved by adding acid to reduce the milk pH, holding the milk for a defined period of time, and raising the pH by the addition of alkali. A preferred sequence for realizing an enhanced removal of the divalent ions from the casein micelles by pH manipulation includes: (1) reduction of the milk pH, at a temperature of ≤15° C., to between 4.9 to 5.4 with a food grade organic acid; (2) holding the milk at this temperature with mild agitation for 30 to 45 minutes; (3) adding food grade alkali to increase the pH of the milk to 5.8 to 6.2, and immediately continuing with the desired processing. A more preferred acid for pH adjustment is an edible organic acid, and the most preferred organic acid is lactic acid. Alternatively, or in addition to acid, edible salts containing monovalent cations optionally may be added to milk prior to filtration. After addition of the monovalent cations the milk is preferably held for 30 minutes with mild agitation prior to UF.

A further method of removing or reducing calcium from casein micelles is to chemically bind calcium using edible sequestering agents such as phosphate or citrate salts. Such agents are known in the art of converting natural cheese into process cheese, process cheese spreads and such products. Such agents are known as “melting salts”. Calcium chelation, using such agents as EDTA in the modification of the solubility characteristics of MPC, was taught by Blazey et al in WO 01/41578, the entirety of which is incorporated by reference, in particular Example 7 at pages 13-14.

Arnaud et al (European patent application EP 16292, the entirety of which is incorporated by reference, in particular paragraphs [0016]-[0021]) teaches that essentially 100% of the calcium can be removed from milk and milk products using treatment with cation exchange resin when charged with monovalent cations. Therein it is further disclosed that cheese treated by cation exchange can be converted into process cheese spread without the need to use melting salts.

Ion exchange may be used to selectively remove divalent cations such as calcium and magnesium and replace these ions with monovalent cations such as sodium, potassium or hydrogen, or combinations thereof. In typical bovine milk, the calcium concentration is about 30 mM, which represents about 85% of the total divalent cation content.

Where ion exchange is used to remove divalent cations according to the process of the present disclosure, the mineral content of the MPC solution can be modified by processing from 10 to 100% of the MPC solution in an ion exchange reactor containing the appropriately charged resin. The ion exchange reactor can contain a cation exchange resin charged with monovalent cations such as hydrogen (H⁺) potassium (K⁺), or sodium (Na⁺) ions. The cation exchange resin can be charged with sodium ions for effecting exchange and removal of the desired quantity of divalent cations, particularly Ca²⁺ and Mg⁺² from the MPC solution.

In the case where 100% of the MPC solution is passed through the ion exchange resin, the calcium removal can be limited to between 20% and 90% of the calcium in the original MPC solution. A procedure for achieving the target calcium depletion level can be to ion exchange part of the MPC solution and then blend this with MPC solution not treated by ion exchange. In one example, >10% but <100% of the original MPC solution is treated by ion exchange to remove 20 to 95% of the calcium in the ion exchanged MPC solution, which can be replaced with sodium. Cation exchange can be used to remove 60 to 85% of the calcium in the ion exchanged MPC solution, which can be replaced with sodium. The ion exchanged MPC solution can then be blended with MPC solution that has not been treated by ion exchange to produce a blend, for example with a calcium depletion level of between 20% and 80% of the calcium in the original MPC solution.

The design of the ion exchange reactor and the amount of ion exchange resin used should promote a suitably rapid reaction rate for the exchange of divalent cations with monovalent cations. The amount of calcium ions removed from the MPC solution is controlled by the selection of the appropriate resin, the MPC concentration, the viscosity in the ion exchange column and the processing conditions within the ion exchange column. Such conditions include residence time, pH, temperature, volume of liquid, volume of resin, exchange capacity and breakthrough characteristics of the resin bed. The operation of the ion exchange process can be performed by those skilled in the art.

In one example the MPC solution added to the ion exchange reactor contains about 10% total solids. The pH is adjusted to about 5.9 prior to ion exchange by addition of a suitable food grade acid, to reduce the fluid viscosity in the ion exchange column. The ion exchange resin can be food approved such as Amberlite SR1L Na. The ion exchange can be conducted at a temperature of about 2 to 60° C. Higher temperatures reduce the fluid viscosity in the ion exchange vessel but 10° C. is suitable to control the growth of microbiological organisms.

In one example, in the blended MPC stream, calcium is depleted by >20% but <90%. The level of calcium depletion in the MPC is selected based on the desired physical and chemical characteristics of the final product and the gel forming process, e.g. the required rates of MPC powder hydration, emulsification and gelation.

In some examples, the milk is concentrated by ultrafiltration to form a retentate of approximately 10% total solids. Optionally, the pH is then adjusted to 6.8, and a portion of the pH-adjusted retentate is subjected to cation exchange, and then blended with the remainder of the pH-adjusted retentate, to achieve a combined retentate with a total calcium depletion of between about 20% to about 90%, optimally about 40% to about 90% depletion.

Optionally, the MPC solution may be diluted (or concentrated) prior to mineral ion adjustment.

Optionally, following mineral ion adjustment, the retentate may be further subjected to pH adjustment and/or filtration as described above.

Optionally, following mineral ion adjustment, or following the optional filtration following the mineral ion adjustment, additive ingredients may be added to the retentate and blended and/or mixed by any method known in the art to achieve homogeneity.

Optionally, following mineral ion adjustment, or following the optional filtration following the mineral ion adjustment, the retentate may be diluted (or concentrated) prior to any further processing.

### Fermentation and Enzymatic Modification

Following mineral ion adjustment, the retentate is subjected to enzymatic modification, which in some examples can include fermentation. Optionally, additional enzymatic modifications may be performed either prior to, simultaneous with, or following fermentation. For example, the retentate may be subjected to fermentation and κ-casein cleavage simultaneously. Any such modification step may be applied to the whole of the process stream, or a portion thereof. Following any such modification step, the untreated portion is subsequently blended with the treated portion. Optionally, the process stream may be homogenised at any convenient stage or stages during the process.

The person skilled in the art will appreciate that a variety of methods or processes may be used to perform fermentation, for example, by introducing a starter culture of lactic acid bacteria (LAB) to the MPC following adjustment of the divalent cation concentration. Thus in some embodiments, the MPC is a lactic acid bacteria fermented MPC. Lactic acid bacteria and their enzymes are major determinants of flavour and fermentation characteristics in fermented dairy products. Flavours are produced through the action of bacteria and their enzymes on proteins, carbohydrates and lipids. It will be appreciated that a suiter starter culture of LAB may be selected from a variety of genera, with non-limiting examples including Lactobacillus, Streptococcus, Leuconostoc, Abiotrophia, Pediococcus, Lactococcus, Aerococcus, Carnobacterium, Enterococcus, Oenococcus, Sporolactobacillus, Tetragenococcus, Vagococcus and Weissella, and combinations thereof. The starter culture to be added to the pasteurised growth medium stream can be mesophilic or thermophilic or a mix and added at 0.0005 to 5%, 0.01 to 0.2%, or about 0.1% of the milk volume. Non-limiting examples of starter cultures are: Streptococcus thermophilus, Lactobacillus bulgaricus, Lactobacillus helveticus, Lactococcus lactis subspecies cremoris, Lactococcus lactis subspecies lactis, and combinations thereof.

The person skilled in the art will appreciate there are a variety of methods for determining the progression and/or completeness of an enzymatic treatment, for example (and without limitation) by measurement of pH, density, gas production, and/or the analysis of biomass and metabolites. For example, an enzymatic treatment may produce acids or bases which alter the pH of the solution, such that monitoring of the pH may give an indication of the progress of the enzymatic treatment.

It will be appreciated that the solution pH may be adjusted, before or after any enzymatic treatment, by the addition of agents that act as acids or bases. The pH of the retentate is adjusted, if necessary, to pH 4.0 to 6.5, preferably 5.2 to 6.5 by the addition of an acidulent. The acidulent can be a food grade acid such as lactic acid, acetic acid, hydrochloric acid, citric acid or sulphuric acid and is diluted with water to approximately 1 to 20% w/w and then added to the reacted milk. Strong acids such as hydrochloric acid, if used can be diluted to 2 to 5% w/w and weak acids such as lactic acid diluted to 10 to 15% w/w before adding to the retentate or fermentate. The acidulent may be dosed in-line, directly into the retentate or fermentate to reduce the pH to the desired pH. Alternatively, an acidulent may be prepared by adding an acid producing micro-organism (a starter culture) to the solution to be treated and preparing the required acid by fermenting a proportion of the lactose present. Such starter cultures are known in the art of cheese making. Moreover, a combination of fermentation and direct acid addition may be used to attain the required acidification. Alternatively, fermentation may be induced by adding a starter culture to the growth medium and holding at a suitable temperature for a suitable time for the generation of acid to lower the pH to a level of between pH 4.0 and pH 6.0, preferably pH 4.6. The treated solution, or fermentate, can be adjusted to its desired final pH is concentrated, such as by using thermal evaporation.

Optionally the solution is cycled in pH between an alkali treatment step followed by an acid treatment step or vice versa. A reduction in pH may be achieved by the direct addition of a permitted food grade acid or a precursor that hydrolyses in the solution to a permitted food acid. A food grade acidulent can be lactic acid and a lactic acid precursor can be glucono-delta-lactone (GDL) or lactic anhydride (lactide). A base can be caustic soda. In some examples, the pH adjustment agent is diluted prior to addition to the solution. The temperature may be adjusted before or after any pH adjustment.

An example of an optional enzymatic modification that may be performed is κ-casein cleavage. κ-casein cleavage may be performed on the liquid fermentate following fermentation, or concurrently with fermentation. A κ-casein cleaving enzyme/agent can be added to the fermentate and the mixture optionally agitated to enhance distribution of the agent. In one example, the κ-casein cleaving agent is rennet, the primary constituent of which is the enzyme known as rennin or chymosin (EC 3.4.24.4), which is typically extracted from calves' stomachs. When rennet is added to milk or milk protein concentrate, within a controlled temperature range and for a period of time, the rennet reacts with the casein protein to cleave to provide κ-casein. Other κ-casein cleaving proteolytic enzymes are known in the art, and may be animal or non-animal derived. Non-limiting examples of κ-casein cleaving agents include papain, ficin, bromelain, bovine pepsin, porcine pepsin, chicken pepsin and the acid proteinases of Rhizomucor miehei, R. pusillus and Cryphonectria parasitica. Mixtures of enzymes may be employed in a single modification step. The choice of single or multiple mixtures of enzymes should be such that the preparation has a high-casein cleaving action on the retentate without excessively hydrolyzing the milk protein. For chymosin (rennet), this concentration can range from 1 part rennet to 25,000 parts starting milk and 1 part rennet to 40,000 parts starting milk. Sufficient κ-casein cleaving agent can be added to the retentate so that the ingredients gel during gel processing. The κ-casein cleaving agent can be held in the retentate for a sufficient time to allow the enzyme to cleave the bond of κ-casein and expose the casein micelle. Optionally, protein behaviour may be modified by the addition of mono-cationic salts of citrate and/or phosphate. Heat may be applied in conjunction with the use of these salts. Optionally, at the end of the κ-casein cleaving step the enzyme can be inactivated to stop its action on the milk protein. It is common practice in the cheese industry to inactivate κ-casein cleaving enzymes at about 75° C. to 90° C. for 10-60 minutes by passing κ-casein cleaving agent containing products through high temperature-short time processors. The time-temperature combinations used to inactive the enzyme will depend upon the enzyme chosen. The enzyme manufacturer's recommendations for inactivation of the product should be followed.

Optionally, the retentate or fermentate may be subjected to enzymatic treatment to lower the concentration of sugars in the retentate or fermentate, through the addition of e.g. a lactase or oxidoreductase enzyme (e.g., hexose oxidase, glucose oxidase, galactose oxidase, pyranose oxidase, and lactose oxidase, catalase, etc.), which are capable of enzymatic conversion of sugars present in the milk (e.g., glucose, galactose, lactose, and other saccharides having an unsubstituted anomeric center) into aldobionate products (e.g., non-reducing sugars and other lactobionate compounds, etc.). The catalytic activity of the enzymes may be increased by mixing oxygen and/or adjusting the pH of the solution with a buffer compound (e.g., calcium hydroxide, calcium carbonate, ammonium carbonate, sodium carbonate, potassium hydroxide, magnesium carbonate, magnesium hydroxide, ammonium hydroxide, sodium hydroxide, aqueous ammonia, etc.). The oxygen may be supplied by pumping compressed air and/or pure oxygen into the solution, and/or by the catalytic reaction of an oxygen precursor (e.g., hydrogen peroxide) with a catalase enzyme. Thus in some embodiments, the MPC is lactose-reduced or lactose-hydrolysed. Hydrolysis of all or a portion of the lactose content of the MPC can increase the sweetness of the MPC.

Optionally, the retentate or fermentate may be subjected to enzymatic hydrolysis, e.g. through treatment with a lipase. Lipases are used in cheese production in the art because they contribute to the production of a typical cheese flavour. Lipases catalyze the cleavage of ester bonds, such as the hydrolysis of triglycerides to glycerol and free fatty acids, especially released short-chain fatty acids contribute directly to the flavour of the cheese. The use of lipases in cheese production can induce the formation of the flavour typical of the particular cheese. The use of lipases of animal origin and the use of lipases of microbial origin for this purpose are known. The enzymatic hydrolysis may be conducted at any suitable pH for the selected enzyme, such as e.g., in the range 2-10, such as, at a pH of 4-9 or 5-7. The lipase is added in a suitable amount, as is determinable by a person skilled in the art, to produce the desired degree of hydrolysis. The enzymatic treatment can be conducted between about 3-60° C., such as at 25-45° C. (e.g., for at least 5 minutes, such as, e.g., for at least 10 minutes or at least 30 minutes, e.g., for 5-60 minutes).

### Heating and Blending

Optionally, prior to or following enzymatic modification, additive ingredients may be added to the fermentate. In one example, pasteurised cream, milk fat, or non-dairy fat or vegetable oil are added to adjust the fat content of the product. It will be appreciated that additive ingredients may be added at various suitable stages throughout the process prior to drying.

Following optional addition of any additive ingredients, the mixture is blended and/or homogenised by e.g. liquid flow or using mechanical mixers such as an in-line static mixer.

Optionally, prior to blending, the mixture is heated, such as to a temperature of about 55° C., by using direct or indirect heating, in order to facilitate with mixing. In the case of direct heating, steam can be injected into the liquid milk composition flow and in the case of indirect beating, a jacketed heater or heat exchanger is associated with the pipe along which the liquid is being pumped.

### Evaporation

Further concentration of the fermentate (now a modified MPC solution) can be accomplished by standard procedures, including evaporation. Methods of evaporation include, but are not limited to the use of falling film, tubular, and swept surface (wiped film) evaporators. Evaporation of the modified MPC solution continues up to a total solids level of about 20% to about 75%, or about 15% to about 35%. Optionally, evaporation made be performed at elevated temperature, for example (and without limitation) about 50° C. to about 60° C. In one example, the moisture content in the dried powder can be less than about 15%. The fat content of the MPC solution, following mineral adjustment or following evaporation, may be adjusted as desired by the addition of cream having a suitable fat content. The salt content of the modified MPC solution may also be adjusted by the addition of sodium chloride and/or potassium chloride as desired, either before or after evaporation.

Optionally, a solution containing divalent cations may be added to the concentrate prior to drying or during the drying process, such that the conditions do not result in gelation of the ingredient during drying. Alternatively, a powdered salt containing divalent cations may be added to the powder during or following drying.

Alternatively (optionally, following a partial concentration of the fermentate via another method, such as evaporation), the concentrated modified MPC solution can optionally be dried to a powder. Methods of drying include, but are not limited to the use of spray, fluidized bed, and freeze dryers. In one example, the drying method is spray drying. The total solids of the product after drying can be about 95%, however may exceed 98%. Optionally, at any stage prior to spray drying, the solution may be heat-treated to denature the proteins. A heat treatment range can be for example between about 60 and 140° C. for between about 5 seconds and 1 hour. The dried modified MPC powder can be shelf stable and packaged and stored until needed to complete gel formation/cheese manufacture at a later date, possibly in a different location. Any additive ingredient, as defined throughout the entirety of this specification, may be also be added at this point, and the composition subsequently mixed to provide a single blended MPC ingredient or food gel ingredient comprising an MPC. The concentrated modified MPC powder (or food gel ingredient thereof) can be used directly in the formulation and formation of dairy food gel products as described according to any aspect, embodiment or example herein.

### Dairy Food Gel Product

The present disclosure provides methods, processes and/or systems for preparing a dairy food gel product, which comprises one or more MPC ingredients and/or dairy food gel ingredients comprising an MPC. The prepared dairy food gel products may be provided according to any embodiments or examples thereof as described herein.

The dairy food gel product may be described in terms of its organoleptic properties. “Organoleptic” refers to the effect or impression produced by any substance on the organs of touch, sight, taste, or smell, and also on the organism as a whole. Organoleptic evaluations of food products are subjective, sensory judgments based on the experience of the evaluator. They can involve observing, feeling, chewing and tasting of the products to judge product appearance, colour, integrity, texture and flavours. The value in these judgments depends on the experience of the evaluator with the specific products in question. This experience is obtained in handling specific food items in a variety of conditions and with repetitive reinforcements over time. Specific product experience is necessary because sensory attributes for a given comestible can vary from product to product.

It will be appreciated that a dairy food gel product may be described in terms of a variety of properties such as texture. The dairy food gel product may possess a texture similar to a variety of cheese or cheese product. In some embodiments, the dairy food gel product may possess a texture similar to a soft, firm, hard, or extra hard cheese. In some examples, the dairy food gel product may possess a texture similar to a sauce. In some examples, the dairy food gel product may possess a texture similar to a foam. In some examples, the dairy food gel product may possess a texture similar to yoghurt. In some examples, the dairy food gel product may possess a texture similar to a soft cheese. Non-limiting examples of soft cheese types include Brie, Camembert, Ricotta, Cottage Cheese, Cream Cheese, Feta, Chevre, Roquefort, Gorgonzola, Bleu d′Auvergne, St. Agur, Boursault, Brillat-Savarin, Chaource, Crottin de Chavignol, Valencay, Saint-Marcellin, Neufchatel, Livarot, and Coulommiers. In some examples, the dairy food gel product may possess a texture similar to a firm cheese. Non-limiting examples of firm cheese types include Gouda, Edam, Havarti, Fontina, Jarlsberg, Manchego, Ossau-Iraty, Provolone, Queso Blanco, Queso Fresco, Red Leicester, Wensleydale, Cheshire, Double Gloucester, Caerphilly, Leicester, Lancashire, Gouda, and Appenzeller. In some examples, the dairy food gel product may possess a texture similar to a hard cheese. Non-limiting examples of hard cheese types include Parmigiano-Reggiano, Cheddar, Grana Padano, Pecorino Romano, Gruyere, Emmental, Asiago, Beaufort, Comte, Manchego, Piave Vecchio, Cantal, Tete de Moine, Tomme de Savoie, Stilton, Danish Blue, Roquefort, Gorgonzola, Bleu d'Auvergne, and Cabrales. In some examples, the dairy food gel product may possess a texture similar to an extra hard cheese. Non-limiting examples of extra hard cheese types include Aged Gouda, Aged Cheddar, Extra Anejo Gouda, Parmesan, Aged Manchego, Asiago Stravecchio, Piave Vecchio Oro Del Tempo, Aged Provolone, Grana Padano Stravecchio, Aged Comte, Etorki Reserve, Wyngaard Dutch Gouda, Tete de Moine Reserve, Beaufort d'Alpage, Old Amsterdam, Gruyere Reserve, and Manchego Viejo. Cheese is the ripened or unripened, soft, semi-hard, hard, or extra hard product made, at least in part, from milk and milk-derived ingredients and having the following moisture content and firmness characteristics (from CODEX Standard for Cheese, CODEX-STANDARD A-6 1999).

TABLE 1
Cheese descriptions
Designation according to firmness and ripening characteristics

| According to firmness: Term 1 | | According to principal |
|---|---|---|
| MFFB % | Designation | ripening: Term 2 |
| <51 | Extra hard | Ripened |
| 49-56 | Hard | Mould ripened |
| 54-69 | Firm/Semi-hard | Unripened/fresh |
| >67 | Soft | In Brine |

*MFFB means Moisture on a Fat Free Basis.

The dairy food gel product may possess a texture similar to other dairy products such as yoghurt, fermented milk, fermented cream, sour cream, quark, butter milk, kefir, dairy shot drinks and cream cheese, ice cream, sauces, or dairy foam. The variety of cheeses and dairy products described above are provided as examples are not intended to limit the scope of this disclosure.

It will be appreciated that a dairy food gel product may be described in terms of one or more properties such as viscosity and firmness. When analysing the properties of the dairy food gel ingredient, viscosity measurements can be conducted to gain information on the overall thickness of the product. Viscosity is commonly measured with a rheometer with a parallel plate geometry, e.g. at shear rate of 10 s⁻¹ at 22° C., or at 1 s⁻¹ at 60° C. Viscosity is commonly perceived as “thickness”, or resistance to flow, and is typically expressed in centipoise (cP). For example, in some embodiments, the dairy food gel product has a viscosity less than 2000 cP, between about 2000 to 10000 cP, between about 15000 to 25000 cP, or greater than 20000 cP. Increasing the liquid content typically decreases the viscosity of the dairy food gel product. Increasing the protein content typically increases the viscosity of the dairy food gel product.

In some embodiments, the dairy food gel product has a viscosity (cP) between about 1000 and about 5000000. In some embodiments, the dairy food gel product has a viscosity (cP) greater than about 1000, 10000, 25000, 50000, 100000, 500000, 1000000, 5000000 or more, or any range therebetween.

Gel firmness may be measured by a back extrusion test with a texture analyzer (e.g. TA.XT Plus, Stable Micro System, Surrey, UK). The travel distance is set to 10 mm, and the travel speed to 1 mm/s. The test is performed after 7 days from production. The maximal force (N or g) obtained by force versus distance curves is used as “gel firmness” parameter, the positive area (N* mm) as degree of deformation, the maximal negative force (N) as ropiness. In some examples, the firmness (in N) ranges from 0.5 to 150 N. Typically, a dairy food gel product that is described by reference to a soft cheese will possess a firmness less than 10 N. Typically, a dairy food gel product that is described by reference to a firm cheese will possess a firmness between about 10 and about 30 N. Typically, a dairy food gel product that is described by reference to a hard or extra hard cheese will possess a firmness greater than 30 N. Increasing the liquid content typically decreases the firmness of the dairy food gel product. Increasing the protein content typically increases the firmness of the dairy food gel product.

The organoleptic properties, texture, viscosity and firmness of the dairy food gel product is determined based on a multivariate profile that describes: the amount and composition of ingredients from which the dairy food gel product is formed, the processing conditions, and the composition of the MPC or dairy food gel ingredient comprising an MPC. It is has been discovered that the properties of the dairy food gel product may be determined either through control of an individual variable (non-limiting examples include, the cationic balance, calcium content, or fat content of the MPC, or the predetermined processing conditions), or through combination with particular variables, viz, the multivariate profile (a non-limiting example includes the cationic balance of the MPC in combination with the predetermined processing conditions). Particular properties of a dairy food gel ingredient may be dependent upon particular variables to a greater or lesser extent than other variables.

In one example, with increasing liquid content, and all other processing conditions and ingredients kept the same, the texture of the resulting dairy food gel ingredient will differ from hard, to soft, to a spread.

In some examples, increasing protein content may increase the firmness of the dairy food gel product with the product becoming more solid-like.

In some examples, increasing fat content may increase the viscosity of the dairy food gel product. Fat can also act as filler within the protein-water matrix of the dairy food gel product, contributing to viscosity through displacement of water.

In some examples, increasing mineral content, particularly increasing calcium content, may increase the firmness of the dairy food gel product. A person skilled in the art will appreciate that calcium may act a ‘scaffold’ for the protein matrix of the dairy food gel product. It will be appreciated that there is a limit to the amount of mineral content which may be comprised by the dairy food gel product, beyond which may increasingly adversely impact one or more properties in the dairy food gel product.

In some examples, increasing carbohydrate content, particularly lactose, may increase the viscosity of the dairy food gel product. Carbohydrate content, particularly lactose, may also act as a filler, and may also be used to displace other components. The extent to which carbohydrate content modulates the viscosity of the dairy food gel product, may in some examples be less significant than other components of the dairy food gel product, such as protein content and fat content.

In another example, the pH may be lowered so as to decrease the firmness of the dairy food gel product. The person skilled in the art will appreciate that by lowering the pH, the activity of the calcium content is regulated, such that less calcium is able to act as a ‘scaffold’ for the protein matrix.

### Milk Protein Content

It will be appreciated that a dairy food gel product may be described in terms of its ‘protein content’, which refers to the total amount of protein in the dairy food gel product, expressed as a weight percentage relative to the total weight of all components of the dairy food gel product. In some embodiments, the dairy food gel product has a protein content (in % w/w) greater than about 1, 5, 10, 15, 20, 25, 30, 35, 40, 45, 50, 55, 60, 65, 70, 75, 80, 85, 90, or 95. In some embodiments, the dairy food gel product has a protein content (in % w/w) less than about 95, 90, 85, 80, 75, 70, 65, 60, 55, 50, 45, 40, 35, 30, 25, 20, 15, 10, 5, or 1. In some embodiments, the dairy food gel product has a protein content in a range provided by any two of the previously described upper and/or lower amounts, for example, wherein the protein content (in % w/w) is between about 1 and 95, 5 and 80, 20 and 95, 10 to 40.

### Fat Content

It will be appreciated that a dairy food gel product may be described in terms of its ‘fat content’, which refers to the total amount of fat in the dairy food gel product, expressed as a weight percentage relative to the total weight of all components of the dairy food gel product. In some embodiments, the dairy food gel product has a fat content (in % w/w) greater than about 1, 5, 10, 15, 20, 25, 30, 35, 40, 45, 50, 55, 60, 65, 70, 75, 80, 85, 90, or 95. In some embodiments, the dairy food gel product has a fat content (in % w/w) less than about 95, 90, 85, 80, 75, 70, 65, 60, 55, 50, 45, 40, 35, 30, 25, 20, 15, 10, 5, or 1. In some embodiments, the dairy food gel product has a fat content in a range provided by any two of the previously described upper and/or lower amounts, for example, wherein the fat content (in % w/w) is between about 1 and 95, 1 and 60, 1 and 50, or 10 to 30.

### Fat to Protein Ratio

It will be appreciated that a dairy food gel product may be described in terms of its ‘fat-to-protein ratio, which refers to the ratio of the total amount of fat to the total amount of protein in the dairy food gel product. In some embodiments, the dairy food gel product has a fat-to-protein ratio greater than about 0.1:1, 0.5:1, 1:1, 1.5:1, 2:1, 3:1 or 5:1. In some embodiments, the dairy food gel product has a fat-to-protein ratio less than about 5:1, 3:1, 2:1, 1.5:1, 1:1, 0.5:1, or 0.1:1. In some embodiments, the dairy food gel product has a fat-to-protein ratio in a range provided by any two of the previously described upper and/or lower amounts, for example, wherein the fat-to-protein ratio is between about 0.1:1 and 5:1, 0.5:1 to 3:1, or 1:1 to 2:1.

### Carbohydrate Content

It will be appreciated that a dairy food gel product may be described in terms of its ‘carbohydrate content’, which refers to the total amount of carbohydrate in the dairy food gel product, expressed as a weight percentage relative to the total weight of all components of the dairy food gel product. In some embodiments, the dairy food gel product has a carbohydrate content (in % w/w) greater than about 0, 1, 2, 3, 4, 5, 6, 7, 8, 9, 10, 11, 12, 13, 14, 15, 16, 17, 18, 19, or 20. In some embodiments, the dairy food gel product has a carbohydrate content (in % w/w) less than about 20, 19, 18, 17, 16, 15, 14, 13, 12, 11, 10, 9, 8, 7, 6, 5, 4, 3, 2, or 1. In some embodiments, the dairy food gel product has a carbohydrate content in a range provided by any two of the previously described upper and/or lower amounts, for example, wherein the carbohydrate content (in % w/w) is between about 0 and 20, or 1 and 10.

### Water Content

It will be appreciated that a dairy food gel product may be described in terms of its ‘water content’, which refers to the total amount of water in the dairy food gel product, expressed as a weight percentage relative to the total weight of all components of the dairy food gel product. In some embodiments, the dairy food gel product has a water content (in % w/w) greater than about 0, 5, 10, 15, 20, 25, 30, 35, 40, 45, 50, 55, 60, 65, 75, 80, 85, 90, or 95. In some embodiments, the dairy food gel product has a water content (in % w/w) less than about 100, 95, 90, 85, 80, 75, 70, 65, 60, 55, 50, 45, 40, 35, 30, 25, 20, 15, 10, or 5. In some embodiments, the dairy food gel product has a water content in a range provided by any two of the previously described upper and/or lower amounts, for example, wherein the water content (in % w/w) is between about 5 and 95, 10 to 90, or 40 and 60.

### Total Solids

It will be appreciated that a dairy food gel product may be described in terms of its ‘total solids content’, which refers to the total amount of solids in the dairy food gel product, expressed as a weight percentage relative to the total weight of all components of the dairy food gel product. In some embodiments, the dairy food gel product has a total solids content (in % w/w) greater than about 1, 5, 10, 15, 20, 25, 30, 35, 40, 45, 50, 55, 60, 65, 70, 75, 80, 85, 90, or 95. In some embodiments, the total solids content may be in a range provided by any two of the previous amounts, such as between about 1 and 95, 25 and 80, 20 and 65, or 20 and 95.

### Mineral Content

It will be appreciated that a dairy food gel product may be described in terms of its ‘calcium content’, which refers to the total amount of calcium in the dairy food gel product, expressed as the amount calcium (e.g. in mmol) relative to the total weight (e.g. in kg) of all components of the dairy food gel product. In some embodiments, the dairy food gel product has a calcium content (in mmol/kg) greater than about 1, 10, 20, 50, 100, 200, 300, 400, 500, 1000, 2000, or 5000. In some embodiments, the dairy food gel product has a calcium content (in mmol/kg) less than about 5000, 2000, 1000, 500, 400, 300, 200, 100, 50, 20, 10, or 1. In some embodiments, the dairy food gel product has a calcium content (in mmol/kg) in a range provided by any of the previously described upper and/or lower amounts, for example, the calcium content (in mmol/kg) is between about 1 to 5000, 1 to 1000, 1 to 200, 20 to 400, or 20 to 100.

It will be appreciated a dairy food gel product may be described in terms of ‘calcium depletion’. Calcium depletion is described as a percentage of the amount of calcium (in mmol) per kg of total protein on a dry basis, relative to the amount of calcium (in mmol) per of kg of total protein typically found in equivalent dairy food gel products produced from an equivalent non-calcium reduced MPC. In some embodiments, the dairy food gel product has a calcium depletion (in %) of greater than about 1, 10, 20, 30, 40, 50, 60, 70, 80, 90, 95. In some embodiments, the dairy food gel product has a calcium depletion (in %) of less than about 100, 95, 90, 80, 70, 60, 50, 40, 30, 20, 10, 1. In some embodiments, the dairy food gel product has a calcium depletion (in %) in a range provided by any of the previous described upper and/or lower amounts, for example, the calcium depletion (in %) is between about 1 to 100, 60 to 95, or 70 to 90. In some embodiments, the dairy food gel product has a calcium depletion of 0%.

It will be appreciated that a dairy food gel product may be described in terms of its ‘monovalent cation content’, which refers to the total amount of monovalent cations in the dairy food gel product, expressed as the amount monovalent cations (e.g. in mmol) relative to the total weight (e.g. in kg) of all components of the dairy food gel product. Suitable monovalent cations include, but are not limited to, Na⁺, K⁺, and combinations thereof. In some embodiments, the dairy food gel product has a monovalent cation content (in mmol/kg) greater than about 1, 100, 200, 500, 1000, 2000, or 5000. In some embodiments, the dairy food gel product has a monovalent cation content (in mmol/kg) less than about 5000, 2000, 1000, 500, 200, 100, or 1. In some embodiments, the dairy food gel product has a monovalent cation content (in mmol/kg) in a range provided by any of the previously described upper and/or lower amounts, for example, the monovalent cation content (in mmol/kg) is between about 1 to 5000, 100 to 1000, 200 to 1000.

It will be appreciated that a dairy food gel product may be described in terms of its ‘divalent cation content’, which refers to the total amount of divalent cations in the dairy food gel product, expressed as the amount divalent cations (e.g. in mmol) relative to the total weight (e.g. in kg) of all components of the dairy food gel product. Suitable divalent cations include, but are not limited to, Ca²⁺, Mg²⁺, Mn²⁺, Zn²⁺ and combinations thereof. In some embodiments, the dairy food gel product has a divalent cation content (in mmol/kg) greater than about 1, 10, 20, 50, 100, 200, 300, 500, 1000, 2000, or 5000. In some embodiments, the dairy food gel product has a divalent cation content (in mmol/kg) less than about 5000, 2000, 1000, 500, 300, 200, 100, 50, 20, 10, or 1. In some embodiments, the dairy food gel product has a divalent cation content (in mmol/kg) in a range provided by any of the previously described upper and/or lower amounts, for example, the divalent content (in mmol/kg) is between about 1 to 5000, 1 to 1000, 1 to 200, or 20 to 100.

It will be appreciated that a dairy food gel product may be described in terms of its ‘monovalent to divalent cation ratio’, which refers to the total amount of monovalent cations in the dairy food gel product relative to the amount of divalent cations in the dairy food gel product, expressed as a ratio (e.g. in mmol/mmol). In some embodiments the dairy food gel product has a monovalent to divalent cation ratio (in mmol/mmol) greater than about 0, 1, 2, 3, 4, 5, 6, 7, 8, 9, 10, 11, 12, 13, 14, 15, 16, 17, 18, 19, 20, 25, 30, 40, 50. In some embodiments the dairy food gel product has a monovalent to divalent cation ratio (in mmol/mmol) less than about 50, 40, 30, 25, 20, 19, 18, 17, 16, 15, 14, 13, 12, 11, 10, 9, 8, 7, 6, 5, 4, 3, 2 or 1. In some embodiments the dairy food gel product has a monovalent to divalent cation ratio (in mmol/mmol) in a range provided by any of the previously described upper and/or lower amounts, for example, the monovalent to divalent cation ratio (in mmol/mmol) is between about 1 to 50, 5 to 30, 5 to 25.

It will be appreciated that a dairy food gel product may be described in terms of its ‘cationic balance’. ‘Cationic balance’ may be expressed as a ratio (for example in mmol·kg/mmol or mg·kg/mg), and refers to the ratio of: (1) the monovalent to divalent cation ratio of the dairy food gel product; relative to (2) the protein content of the dairy food gel product. The protein content of the dairy food gel product will be understood to refer to the weight of the protein component of the dairy food gel product, relative to the total weight of the dairy food gel product (which may, for example, be expressed as kg/kg). In some embodiments, the dairy food gel product has a cationic balance (in mmol·kg/mmol) is greater than about 0.5, 1, 5, 15, 10, 20, 30, 40, 50, 60, 70, 80, 90, 100, 200, 300, or 500. In some embodiments, the dairy food gel product has a cationic balance (in mmol·kg/mmol) is less than about 500, 300, 200, 100, 90, 80, 70, 60, 50, 40, 30, 20, 15, 10, 5, 1, or 0.5. In some embodiments the dairy food gel product has a cationic balance (in mmol·kg/mmol) in a range provided by any of the previously described upper and/or lower amounts, for example, the cationic balance (in mmol·kg/mmol) is between about 0.5 and 500, 1 to 100, 1 to 300, or 15 to 50.

It will be appreciated that dairy food gel product may also be described in terms of the amount of calcium relative to the amount of protein in the dairy food gel product. In other words, a dairy food gel product may be described in terms of its ‘calcium to protein ratio’, which refers to the total amount of calcium (e.g. in g, or alternatively mmol) in the dairy food gel product relative to the amount of protein (e.g. in kilograms) in the dairy food gel product, expressed as a ratio (e.g. in terms of g/kg, or alternatively, mmol/kg). In some embodiments the dairy food gel product has a calcium to protein ratio (in g/kg) less than about 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.5, 11, 11.5, 12, 12.5, 13, 13.5, 14, 14.5, 15, 20, 25, 30, 35, 40, 45 or 50. In some embodiments the dairy food gel product has a calcium to protein ratio (in g/kg) between about 1 and about 50, between about 5 and about 50, between about 10 and about 50, between about 0.1 and about 15, between about 0.5 and about 15, between about 1 and about 15, between about 1.5 and about 15, between about 0.1 and about 10, between about 0.5 and about 10, between about 1 and about 10, between about 1.5 and about 10, between about 0.1 and about 8, between about 0.5 and about 8, between about 1 and about 8, between about 1.5 and about 8.

pH

It will be appreciated that a dairy food gel product may be described in terms of its ‘pH’. In some embodiments, the dairy food gel product has a pH greater than about 3, 3.5, 4, 4.5, 5, 5.5, 6, 6.5, 7, 7.5, 8, 8.5, 9, 9.5, or 10. In some embodiments, the dairy food gel product has a pH less than about 10, 9.5, 9, 8.5, 8, 7.5, 7, 6.5, 6, 5.5, 5, 4.5, 4, 3.5, 3. In some embodiments, the dairy food gel product has a pH in a range provided by any of the previously described upper and/or lower amounts, for example, the dairy food gel product is between about 3 to 10, 4 to 8, 4.5 to 8, or 5 to 7.

### System for Food Processing

The present disclosure may also provide a food processing system for enabling on-demand personalised preparation of customisable dairy food gel products. The food processing system may be configured to be used in any process according to any aspect, embodiment or example thereof as described herein. In some embodiments, there may be provided a food processing system configured for preparing from one or more ingredients a plurality of dairy food gel products having a range of predetermined organoleptic properties, wherein at least one ingredient is a milk protein concentrate (MPC) or dairy food gel ingredient comprising an MPC. The MPC may be provided according to any embodiment or example thereof as described herein. For example, the MPC may be selected from a fermented MPC (fMPC), calcium reduced MPC (cMPC), and a fermented calcium reduced MPC (fcMPC). The system may comprise a dairy food gel product according to any embodiment or example thereof as described herein.

In some embodiments, the food processing system may comprise:
a food processor base configured for receiving the one or more ingredients and a liquid,
a heating system configured for heating any of the one or more ingredients and liquid,
optionally a mixing system for mixing together any of the one or more ingredients and liquid, and
a system controller configured for receiving a user input for selection of a dairy food gel product having predetermined organoleptic properties (e.g. type of cheese product), wherein the system controller then selects predetermined process conditions for the selected dairy food gel product having predetermined organoleptic properties, wherein the process conditions comprise predetermined parameters selected from liquid content, process temperature, and process duration, and optional mixing, for obtaining the selected dairy food product from the plurality of dairy food gel products having a range of predetermined organoleptic properties. The system controller may control operation of the food processor base, the heating system and optionally the mixing system based on the selected predetermined process conditions for the selected dairy food gel having predetermined organoleptic properties, to obtain the selected dairy food product from the plurality of dairy food gel products having a range of predetermined organoleptic properties.

It will be appreciated that the system may comprise any embodiment, example, or component of the process as described herein. For example, the system may comprise any embodiment, example or component of the process as referred to in FIG. 1 and/or as described herein.

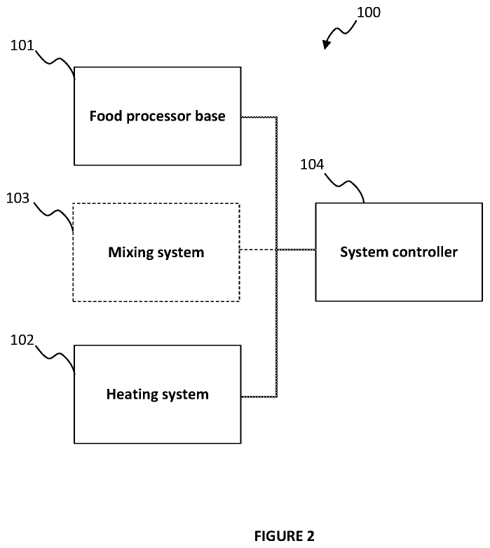

The food processing system may be more fully understood by having reference to FIG. 2, which illustrates a food processing system 100 including a food processor base 101, a heating system 102, an optional mixing system 103, and a system controller 104, according to an embodiment of the present disclosure.

The food processor base may be configured for receiving any of the one or more ingredients and the liquid, each of which may be provided separately or simultaneously. The food processor base can contain the one or more ingredients and liquid, which may be optionally mixed by the mixing system prior to processing by heating and/or during heating by the heating system. The food processor base or system may be configured to house any of the one or more ingredients and liquid prior to combining and heating to form the dairy food gel product.

The heating system may comprise any embodiment, example, or component of a heating system or a heating means of the process as described herein. The heating system may be configured for separately pre heating any one or more of the ingredients and/or liquid, and/or heating together the one or more ingredients and liquid once combined and optionally mixed.

The mixing system may comprise any embodiment, example, or component of a mixing apparatus or mixing means of the process as described herein. The mixing system may be configured for pre-mixing any one or more of the ingredients, prior to addition of the liquid, and/or mixing together the one or more ingredients and liquid once combined.

The system controller may comprise any embodiment, example, or component of a system controller apparatus or system controller means of the process as described herein. For example, the system controller may allow a user to select and input a dairy food gel product type (e.g. cheese type such as cheddar cheese, see above including Table 1), which can access and action pre-selected conditions for preparing the selected type of dairy food gel product. For example, the user selection of product type may be of any of the above described types and/or property selections of cheese products.

The system controller may comprise one or more processors and data storage devices. The one or more processors may each comprise one or more processing modules, such a heating modules, and/or mixing modules, and the one or more storage devices may each comprise one or more storage elements. The one or more processors, modules and storage elements may be at one site, e.g., co-located with the food processor base, the heating system and optionally the mixing system in, for example, an integrated apparatus, or distributed across multiple sites and interconnected by a communications network such as the internet.

The processing modules can be implemented by a computer program or program code comprising program instructions. The computer program instructions can include source code, object code, machine code or any other stored data that is operable to cause a processor to perform the methods described. The computer program can be written in any form of programming language, including compiled or interpreted languages and can be deployed in any form, including as a stand-alone program or as a module, component, subroutine or other unit suitable for use in a computing environment. The data storage device may include suitable computer readable media such as volatile (e.g. RAM) and/or non-volatile (e.g. ROM, disk) memory or otherwise.

In one embodiment, there is provided a food processing system configured for preparing from one or more ingredients a plurality of dairy food gel products having a range of predetermined organoleptic properties, wherein at least one ingredient is a milk protein concentrate (MPC) or dairy food gel ingredient comprising an MPC, wherein the MPC is selected from a fermented MPC (fMPC), calcium reduced MPC (cMPC), and a fermented calcium reduced MPC (fcMPC), and wherein the food processing system comprises:
a food processor base configured for receiving the one or more ingredients and a liquid,
a heating system configured for heating any of the one or more ingredients and liquid,
optionally a mixing system for mixing any of the one or more ingredients and liquid, and
a system controller configured for receiving a user input for selection of a dairy food gel product having predetermined organoleptic properties, wherein the system controller selects predetermined process conditions for the selected dairy food gel product having predetermined organoleptic properties, and wherein the process conditions comprise predetermined parameters selected from liquid content, process temperature, and process duration, and optional mixing, to obtain the selected dairy food product from the plurality of dairy food gel products having a range of predetermined organoleptic properties.

The food processor base, the heating system, the mixing system and/or the system controller of this embodiment may be configured in accordance with any embodiment, example, or component of a food processor base, heating system, mixing system or system controller as described herein.

### EXAMPLES

The present disclosure is further described by the following dairy food gel products, which include cheese product examples. Cheeses are a specific variant of food gels and can possess a range of properties and compositions depending on cheese type. It is to be understood that the following description is for the purpose of describing particular embodiments only and is not intended to be limiting with respect to the above description.

### Materials and Methods

The monovalent to divalent cation ratio can be calculated as follows:

$$Monovalent : divalent cation ratio = \frac{Sodium ions ( {Na}^{+} ) + Potassium ions ( {K}^{+} )}{Magnesium ions ( {Mg}^{2 +} ) + Calcium ions ( {Ca}^{2 +} )}$$

This cation ratio can be expressed either in mg/mg, or as mmol/mmol.

The cation balance per unit protein can be calculated as follows:

$$Cationic balance = \frac{Monovalent : divalent ion ratio ( \frac{mg}{mg} or \frac{mmol}{mmol} )}{Protein fraction ( kg / kg product )}$$

This ratio can be expressed either as mg·kg/mg, or mmol·kg/mmol.

Table 2 below provides some compositional information for novel MPCs of MPC A, MPC B, MPC C, MPC D, MPC E and MPC F, and also for MPC4862 and MPC470, which are used as ingredients in the Examples.

TABLE 2
Ingredient compositions for examples

| | | Ingredient | | | | | | | |
|---|---|---|---|---|---|---|---|---|---|
| | | | | | | | | NZMP | NZMP |
| Composition | | MPC A | MPC B | MPC C | MPC D | MPC E | MPC F | MPC4862 | MPC470 |
| Water | % w/w | 4.09% | 2.11% | 2.97% | 9.48% | 1.59% | 3.25% | 4.70% | 4.40% |
| Total solids | % w/w | 95.91% | 97.89% | 97.03% | 90.52% | 98.41% | 96.75% | 95.30% | 95.60% |
| Total protein | % w/w | 38.15% | 39.36% | 33.24% | 78.28% | 83.13% | 37.07% | 82.40% | 70.00% |
| Fat | % w/w | 51.40% | 51.47% | 58.45% | 1.12% | 1.40% | 51.79% | 1.60% | 1.40% |
| Carbohydrate | % w/w | 2.77% | 2.58% | 1.35% | 4.08% | 4.30% | 3.67% | 4.20% | 17.00% |
| Total ash | % w/w | 3.45% | 3.63% | 3.07% | 6.85% | 7.30% | 3.44% | 7.10% | 7.20% |
| Fat to protein | — | 1.35 | 1.31 | 1.76 | 0.01 | 0.02 | 1.40 | 0.02 | 0.02 |
| ratio | | | | | | | | | |
| Calcium | mmol/kg | 22 | 68 | 34 | 36 | 95 | 36 | 70 | 544 |
| Total monovalent | mmol/kg | 548 | 441 | 453 | 1121 | 1038 | 514 | 1031 | 274 |
| cations | | | | | | | | | |
| Total divalent | mmol/kg | 24 | 77 | 38 | 39 | 102 | 40 | 75 | 581 |
| cations | | | | | | | | | |
| Monovalent | mmol/mmol | 22.53 | 5.75 | 12.08 | 28.79 | 10.21 | 12.99 | 13.71 | 0.47 |
| to divalent | | | | | | | | | |
| cation ratio | | | | | | | | | |
| Cationic balance | mmol · kg/mmol | 59.04 | 14.61 | 36.34 | 36.78 | 12.29 | 35.05 | 16.63 | 0.67 |
| Calcium depletion | % | 91.39% | 74.82% | 84.86% | 92.98% | 83.17% | 86.34% | 87.16% | 0.57% |
| pH | — | 6.24 | 6.25 | 5.70 | 6.16 | 6.14 | 6.18 | 6.80 | 6.80 |

### Example 1-1—MPC A Production

Fresh whole milk was received, pasteurised and separated into skim milk and cream. The skim milk was cooled to 10° C. then processed by ultrafiltration (UF) in a system with a molecular weight cut-off of 5 kDa. Diafiltration was then applied to achieve a protein content in the MPC retentate of 85% of the total solids. This retentate was then diluted 1:1 with demineralised water and had its pH adjusted using lactic acid to a pH of 5.87.

The MPC retentate was introduced into an ion exchange column containing food approved RHOM & HAAS AMBERLITE SRIL ion exchange resin. Approximately 105 L of sodium charged resin was loaded into a stainless steel vessel. The MPC retentate was then treated in this ion exchange column and collected in a storage vessel. Upon completion the retentate had a calcium depletion of greater than 90%. The calcium depleted retentate was then blended with cream to a fat to protein ratio of 1.35:1 to form a fat enriched, calcium depleted, MPC retentate.

Microbial rennet enzyme (FROMASE 750XLG) and mixed starter culture (Lactococcus lactis subsp. lactis and Lactococcus lactis subsp. cremoris) was added to the MPC retentate and fermented to a pH of 6.1 to form a fermentate.

The renneted MPC fermentate was then evaporated at 50-55° C. to a total solids of 33% and then spray dried into a powder with the final composition shown in Table 2.

### Example 1-2—MPC B Production

Fresh whole milk was received, pasteurised and separated into skim milk and cream. The skim milk was cooled to 10° C. then processed by Ultrafiltration (UF) in a system with a molecular weight cut-off of 5 kDa. Diafiltration (DF) was then applied to achieve a protein content in the MPC retentate of 85% of the total solids. This retentate was then diluted 1:1 with demineralised water and had its pH adjusted using lactic acid to a pH of 5.87.

The MPC retentate was introduced into an ion exchange column containing food approved RHOM & HAAS AMBERLITE SRIL ion exchange resin. Sodium charged resin was loaded into a stainless steel vessel. The MPC retentate was then treated in this ion exchange column and collected in a storage vessel. Upon completion the retentate had a calcium depletion of 78%. The calcium depleted MPC retentate was then blended with cream to a fat to protein ratio of 1.3:1 to form a fat enriched MPC retentate.

Microbial rennet enzyme (FROMASE 750XLG) and mixed starter culture (Lactococcus lactis subsp. lactis and Lactococcus lactis subsp. cremoris was then added to the fat enriched MPC retentate and fermented to a pH of 6.1 to form a fermentate. The fermentate was then evaporated at 50-55° C. to a total solids of about 38% and then spray dried into a powder with the final composition shown in Table 2.

### Example 1-3—MPC C Production

Fresh whole milk was received, pasteurised and separated into skim milk and cream. The skim milk was cooled to 10° C. then processed by Ultrafiltration (UF) in a system with a molecular weight cut-off of 5 kDa. Diafiltration (DF) was then applied to achieve a protein content in the MPC retentate of 85% of the total solids. This retentate was then diluted 1:1 with demineralised water.

The MPC retentate was introduced into an ion exchange column containing food approved RHOM & HAAS AMBERLITE SRIL ion exchange resin. Sodium charged resin was loaded into a stainless steel vessel. The MPC retentate was then treated in this ion exchange column and collected in a storage vessel. Upon completion the retentate had a calcium depletion of 85%. The calcium depleted retentate was then further diluted 1:1 with demineralised water.

Microbial rennet enzyme (FROMASE 750XLG) and mixed starter culture (Lactococcus lactis subsp. lactis and Lactococcus lactis subsp. cremoris) were then added to the fat enriched MPC retentate and fermented to a pH of 5.5 to form a fermentate. The fermentate was then blended with a cream to a fat to protein ratio of 1.75:1 to form a fat enriched fermentate. The fermentate was then spray dried into a powder with the final composition shown in Table 2.

### Example 1-4—MPC D Production

Fresh whole milk was received, pasteurised and separated into skim milk and cream. The skim milk was cooled to 10° C. then processed by ultrafiltration (UF) in a system with a molecular weight cut-off of 5 kDa. Diafiltration was then applied to achieve a protein content in the MPC retentate of 85% of the total solids. This retentate was then diluted 1:1 with demineralised water and had its pH adjusted using lactic acid to a pH of 5.87.

The MPC retentate was introduced into an ion exchange column containing food approved RHOM & HAAS AMBERLITE SRIL ion exchange resin. Approximately 105 L of sodium charged resin was loaded into a stainless steel vessel. The MPC retentate was then treated in this ion exchange column and collected in a storage vessel. Upon completion the retentate had a calcium depletion of greater than 90%.

Microbial rennet enzyme (FROMASE 750XLG) and mixed starter culture (Lactococcus lactis subsp. lactis and Lactococcus lactis subsp. cremoris) was added to the MPC retentate and fermented to a pH of 6.1 to form a fermentate. The renneted MPC fermentate was then evaporated at 50-55° C. to a total solids of 19% and then spray dried into a powder with the final composition shown in Table 2.

### Example 1-5—MPC E Production

NZMP MPC4862 powder was reconstituted with demineralised water in a high shear mixer to form an MPC retentate with a total solids of 5%. Microbial rennet enzyme (FROMASE 750XLG) and mixed starter culture (Lactococcus lactis subsp. lactis and Lactococcus lactis subsp. cremoris) was added to the MPC retentate and fermented to a pH of 6.2 to form a fermentate. The renneted MPC fermentate was then evaporated at 50-55° C. to a total solids of 16% and then spray dried into a powder with the final composition shown in Table 2.

### Example 1-4—MPC F Production

Fresh whole milk was received, pasteurised and separated into skim milk and cream. The skim milk was cooled to 10° C. then processed by ultrafiltration (UF) in a system with a molecular weight cut-off of 5 kDa. Diafiltration was then applied to achieve a protein content in the MPC retentate of 85% of the total solids. This retentate was then diluted 1:1 with demineralised water and had its pH adjusted using lactic acid to a pH of 5.85.

The MPC retentate was introduced into an ion exchange column containing food approved RHOM & HAAS AMBERLITE SRIL ion exchange resin. Approximately 105 L of sodium charged resin was loaded into a stainless steel vessel. The MPC retentate was then treated in this ion exchange column and collected in a storage vessel. Upon completion the retentate had a calcium depletion of greater than 85%. The calcium depleted retentate was then blended with cream to a fat to protein ratio of 1.4:1 to form a fat enriched, calcium depleted, MPC retentate.

Microbial rennet enzyme (FROMASE 750XLG) and mixed starter culture (Lactococcus lactis subsp. lactis and Lactococcus lactis subsp. cremoris) was added to the MPC retentate and fermented to a pH of 6.1 to form a fermentate.

The renneted MPC fermentate was then evaporated at 50-55° C. to a total solids of 32% and then spray dried into a powder with the final composition shown in Table 2.

### Example 2—Simple Cheese Textures

On-demand gel technology can be used to create food materials with a range of textures from a limited number of input ingredients. In one example, using only a combination of water and MPC A, a variety of cheese textures were created by varying the processing parameters of liquid content. The process steps include:
an amount of water was added to a temperature-controlled kitchen mixer (Vorwerk Thermomix TM06) and heated to 75° C., with mixing at a speed setting of 3 (equivalent to 500 rpm) until the temperature was obtained;
an amount of MPC A was then added, and then mixed for 3 minutes;
mixture was then removed from the mixer and chilled to 4° C. in a plastic container.

From this method, different cheese textures were produced depending only the quantities of novel MPC A and water. The table below displays the different formulations used, the resulting compositions and a description of the textures created.

TABLE 3
Simple cheese textures formulations, compositions and key textural attributes

| | | Simple cheese | Simple soft | Simple young |
|---|---|---|---|---|
| Formulation | Unit(s) | spread | cheese | cheddar |
| Total | g | 1000 | 1001 | 1000 |
| Water | g | 687 | 583 | 479 |
| Novel MPC A | g | 313 | 418 | 521 |
| Composition | | | | |
| Water | % w/w | 69.50% | 59.20% | 48.70% |
| Total solids | % w/w | 30.50% | 40.80% | 51.30% |
| Total protein | % w/w | 11.99% | 15.89% | 20.10% |
| Fat | % w/w | 16.30% | 21.60% | 27.01% |
| Carbohydrate | % w/w | 0.86% | 1.24% | 1.56% |
| Total ash | % w/w | 1.05% | 1.44% | 1.76% |
| Fat to protein ratio | | 1.36 | 1.36 | 1.34 |
| Calcium | mmol/kg | 7 | 9 | 11 |
| Total monovalent cations | mmol/kg | 174 | 235 | 288 |
| Total divalent cations | mmol/kg | 8 | 10 | 12 |
| Monovalent to divalent | | 23.03 | 23.37 | 23.39 |
| cation ratio | | | | |
| Cationic balance | | 191.98 | 147.14 | 116.39 |
| Calcium depletion | % | 91.47% | 91.51% | 91.74% |
| pH | | 6.00 | 5.92 | 5.89 |
| Physical & sensory | | | | |
| properties | | | | |
| Viscosity at 1 s⁻¹ and 60° C. | cP | 27370 | 76915 | 295065 |
| Firmness | N | 0.27 | 0.86 | 5.08 |
| Sensory description | | Smooth, no lumps, | Holds its shape | Firmness similar |
| | | reminiscent of | when spooned | to blocks of |
| | | queso/cheese dip | | cheese such as |
| | | | | Edam and |
| | | | | Havarti |

### Example 3—Cheeses with Different Textures

On-demand gel technology can be used to create food materials with a range of textures from a limited number of input ingredients. In one example, using only a combination of water and MPC A, a variety of cheese textures were created by varying the processing parameters of process temperature, and process shear and process duration. The process steps include:
an amount of water was added to a temperature-controlled kitchen mixer (Vorwerk Thermomix TM06) and heated to the required temperature, with mixing at the required speed to control the process shear until the temperature was obtained;
an amount of MPC A was then added, and then mixed for the required time;
mixture was then removed from the mixer and chilled to 4° C. in a plastic container.

From this method, different cheese textures were produced depending only the quantities of novel MPC A and water at the various process conditions. The table below displays the different formulations used, the resulting compositions and a description of the textures created as determined by a sensory panel.

TABLE 4
Simple cheese textures formulations, compositions and key textural attributes

| | | | | Low shear, | High |
|---|---|---|---|---|---|
| Formulation | Unit(s) | No shear | High shear | long time | temperature |
| Process mixing speed | rpm | 0 | 1200 | 100 | 500 |
| Process temperature | ° C. | 75 | 75 | 75 | 90 |
| Process time | mins | 3 | 3 | 15 | 3 |
| Total | g | 1000 | 1000 | 1000 | 1000 |
| Water | g | 479 | 479 | 479 | 479 |
| Novel MPC A | g | 521 | 521 | 522 | 522 |
| Composition | | | | | |
| Water | % w/w | 48.80% | 48.70% | 50.10% | 48.80% |
| Total solids | % w/w | 51.20% | 51.30% | 49.90% | 51.20% |
| Total protein | % w/w | 19.71% | 20.22% | 19.59% | 20.22% |
| Fat | % w/w | 27.25% | 27.26% | 26.45% | 27.32% |
| Carbohydrate | % w/w | 1.52% | 1.53% | 1.48% | 1.59% |
| Total ash | % w/w | 1.80% | 1.78% | 1.74% | 1.77% |
| Fat to protein ratio | | 1.38 | 1.35 | 1.35 | 1.35 |
| Calcium | mmol/kg | 11 | 11 | 11 | 11 |
| Total monovalent | mmol/kg | 302 | 284 | 277 | 290 |
| cations | | | | | |
| Total divalent cations | mmol/kg | 13 | 13 | 12 | 13 |
| Monovalent to | | 24.04 | 22.55 | 22.62 | 23.02 |
| divalent cation ratio | | | | | |
| Cationic balance | | 121.92 | 111.47 | 115.47 | 113.84 |
| Calcium depletion | % | 91.46% | 91.60% | 91.60% | 91.62% |
| pH | | 5.89 | 5.91 | 5.89 | 5.89 |
| Physical & sensory | | | | | |
| properties | | | | | |
| Viscosity at 1 s⁻¹ and | cP | 182835 | 582455 | 136425 | 199693 |
| 60° C. | | | | | |
| Firmness | N | 4.00 | 7.15 | 3.81 | 4.44 |
| Sensory description | | Smooth, soft | Slightly | Soft texture, | Firmness like |
| | | (softer than | firmer (like | moderately | Havarti, |
| | | Havarti); | Havarti), | crumbly, | weakly |
| | | weak to | moderately | moderately | crumbly, |
| | | moderately | crumbly | to strongly | strongly |
| | | crumbly | | sticky | sticky |

### Example 4

A variety of dairy food gel products (Examples 4-1 to 4-7) were produced according to the process described herein. The compositional information of Examples 4-1 to 4-7 is summarized in Table 5. All amounts are given as a percentage (w/w) of the total gel product.

### Example 4-1: Cheddar-Style Cheese

An on-demand dairy gel product with the texture of a cheddar-style cheese was produced, possessing a firm texture with a degree of crumbliness depending on the maturity. The cheddar-like texture was achieved by combining MPC F powder (about 18%) and MPC4862 powder (about 39%), with water (about 36%), salt (about 2%, comprising sodium chloride and calcium chloride dehydrate) and acid (about 4%). Water was heated to 75° C. in a temperature-controlled kitchen mixer (Vorwerk Thermomix TM06), adding the salts and acid, then adding the powder while mixing at a speed setting of 3 (equivalent to 500 rpm) and mixing for 3 minutes. The cheese was then removed and chilled to 4° C. in a plastic container. The resulting gel has a texture that could be cut with a knife, producing a moderately crumbly cheese.

### Example 4-2: Mozzarella—Style Cheese

An on-demand dairy gel product with the texture of a mozzarella-style cheese was produced, possessing characteristic stretchiness and bouncy texture. The product was obtained by combining MPC B powder (about 54%) with water (about 44%), sodium chloride (about 1.7%) and citric acid (about 0.3%). Water was heated to 75° C. in a temperature-controlled kitchen mixer (Vorwerk Thermomix TM06), adding the salts and acid, then adding the powder while mixing at a speed setting of 3 (equivalent to about 500 rpm) and mixing for 3 minutes. The cheese was then removed and chilled to 4° C. in a plastic container. The resulting gel forms a cohesive block that when melted possesses typical mozzarella stretch properties.

### Example 4-3: Cream Cheese-Style Cheese

An on-demand dairy gel product with the texture of a cream cheese-like product was produced. Cream cheese typically contains a higher fat content, and therefore higher fat to protein ratio, than other cheese varieties giving it a creamy mouthfeel and spreadable consistency. The dairy food gel product was obtained by heating water (about 47%) in a Thermomix to 75° C. before adding MPC C powder (about 31%), butter (about 20%), salt (about 1%, sodium chloride), acid (about 0.2%) and carrageenan stabilizer (about 0.1%) and mixing for about 3 minutes at mixer speed 3 (equivalent to about 500 rpm). The resulting composition is smooth and spreadable cream cheese-like product.

### Example 4-4: Cream Cheese Sauce

An on-demand dairy gel product with the texture of a cheese sauce was produced. Cheese sauces such as nacho cheese have a significantly higher moisture content than block cheeses to make them pourable. The dairy gel product was obtained by heating water (about 70%) in a Thermomix to 75° C. before adding cream-enriched MPC powder (about 23% F), MPC 4862 powder (about 6%), salt (about 0.2%, sodium chloride) and flavourings (about 0.6%) and mixing for about 3 minutes at mixer speed 3 (equivalent to about 500 rpm). The resulting on-demand cheese sauce was a thick sauce that was smooth with excellent pourability, similar to jar cheese.

### Example 4-5: Aerated Dairy Foam

An on-demand dairy gel product with the texture of an aerated dairy foam was produced, which is typically high in fat and low in protein. The dairy food gel ingredient was obtained by combining about 17% MPC F with water (about 32%), clarified butter (about 50%), salt (about 1.2%, sodium chloride/calcium chloride dihydrate) and lactic acid (about 0.5%). The water was heated in a Thermomix TM06 kitchen mixer to 75° C., then the ingredients added while mixing together at a speed of about 500 rpm for about 3 minutes. This was left to cool before whipping using a benchtop kitchen mixer with whisk attachment. The foam had a buttery flavour with an aerated consistency comparable to buttercream icing.

### Example 4-6: Flavoured Cheese Block

An on-demand dairy gel product with the texture of a firm cheese block was produced. The dairy food gel product was obtained by combining about 18% MPC A powder and MPC 4862 powder (about 39%), with caramel flavouring powder (about 1%), water (about 36%), about 15-25% cream and salt (about 1.5%, sodium chloride), leaving to hydrate for 10 minutes, heating for 1 minute in a microwave to 70° C. before mixing in 1.0% cheese powder and lactic acid (about 4%), heating for a further 20 seconds and leaving to cool. The resulting product was a firm and rubbery cheese block that could be cleanly cut into even slices, but with a sweet caramelized flavour.

### Example 4-7: Food with Cheese Product

A Chinese-style filled steamed bun was prepared according to the following procedure:
dough formed of a mixture of 500 g plain flour, 2 teaspoons dry yeast, 1.5 teaspoons baking powder, 2 tablespoons granulated sugar, 300 g warm milk and 2 teaspoons of salt were left to ferment at room temperature for approximately 1 hour before being divided into approximately 60 g pieces, rolled into balls then left to rest for 15 minutes;
a cheese of MPC F (about 45%), water (about 55%) and salt (about 0.1%, sodium chloride) was mixed in a Thermomix TM06 kitchen mixer, with water heated to 75° C. before adding the remaining ingredients and mixing at about 500 rpm for 3 minutes until fully combined into a cheese mass;
each dough ball was filled with approximately 50 g of paste and left to rest at room temperature for approx. 30 minutes;
each dough ball was steamed over boiling water for 14 minutes;
steaming process transformed dough ball into a steamed bun, with the filling cheese transformed into a flowing white cheese with a smooth melted and flowing texture.

In some examples, the dairy food gel products can be consumed after production at ambient temperatures for up to about 8 h, 7 days if refrigerated or longer if packaged accordingly.

TABLE 5
Composition and formulation data for Examples 4-1 to 4-7

| | | | | | | |
|---|---|---|---|---|---|---|
| | | 3. Cream | | | | 7. Food |
| 1. Cheddar | 2. Mozzarella | cheese | 4. Cream | 5. Aerated | 6. Flavoured | product |
| style cheese | style cheese | style cheese | cheese sauce | dairy foam | cheese block | with cheese |

COMPOSITION

| | | | | | | | | |
|---|---|---|---|---|---|---|---|---|
| Water | % w/w | 58.80% | 45.80% | 50.80% | 70.40% | 39.57% | 48.00% | 55.20% |
| Total solids | % w/w | 41.20% | 54.20% | 49.20% | 29.60% | 60.43% | 52.00% | 44.80% |
| Total protein | % w/w | 28.20% | 20.42% | 10.85% | 13.91% | 5.87% | 32.67% | 16.78% |
| Fat | % w/w | 7.16% | 28.33% | 35.96% | 12.01% | 49.20% | 8.44% | 23.55% |
| Carbohydrate | % w/w | 1.33% | 1.48% | 0.61% | 1.08% | 0.86% | 8.07% | 1.67% |
| Total ash | % w/w | 3.78% | 3.37% | 1.79% | 1.62% | 1.46% | 2.70% | 2.45% |
| Fat to protein ratio | — | 0.25 | 1.39 | 3.32 | 0.86 | 8.38 | 0.26 | 1.40 |
| Calcium | mmol/kg | 64.37 | 41.17 | 12.35 | 15.34 | 57.39 | 32.93 | 17.76 |
| Total monovalent cations | mmol/kg | 529.64 | 531.32 | 319.03 | 252.07 | 156.00 | 460.63 | 400.89 |
| Total divalent cations | mmol/kg | 66.27 | 46.52 | 13.86 | 17.73 | 58.36 | 35.14 | 19.66 |
| Monovalent to divalent | — | 7.99 | 11.42 | 23.02 | 14.22 | 2.67 | 13.11 | 20.39 |
| cation ratio | | | | | | | | |
| Cationic balance | — | 28.34 | 55.95 | 212.23 | 102.22 | 45.54 | 40.13 | 121.54 |
| pH | — | 5.89 | 5.47 | 5.26 | 6.18 | 5.20 | 6.32 | 5.72 |

PHYSICAL PROPERTIES

| | | | | | | | | |
|---|---|---|---|---|---|---|---|---|
| Viscosity at 1 s⁻¹ | cP | 571155 | 598855 | 3625 | 36809 | 25133 | 4598400 | 48297 |
| and 60° C. | | | | | | | | |
| Firmness | N | 5.91 | 10.13 | 0.66 | 0.13 | 2.47 | 23.21 | 1.56 |

FORMULATION

| | | | | | | | | |
|---|---|---|---|---|---|---|---|---|
| Total | g | 1400.97 | 987.12 | 1003.10 | 1000.29 | 1000.15 | 1132.50 | 1010.27 |
| Water | g | 765.98 | 437.52 | 470.60 | 698.61 | 316.95 | 518.90 | 550.21 |
| Novel MPC B | g | — | 529.70 | — | — | — | — | — |
| Novel MPC C | g | — | — | 312.00 | — | — | — | — |
| Novel MPC F | g | 180.43 | — | — | 230.25 | 165.30 | 181.80 | 450.06 |
| NZMP MPC4862 | g | 394.41 | — | — | 63.71 | — | 391.00 | — |
| Butter | g | — | — | 204.50 | — | 500.20 | — | — |
| Lactic acid 80% w/w | g | 38.16 | — | 5.00 | — | 5.60 | 32.00 | — |
| Salt | g | 14.37 | 17.30 | 10.00 | 2.06 | 4.21 | 2.80 | 10.00 |
| Stabilisers/flavourings | g | — | — | 1.00 | 5.66 | — | — | — |
| Caramel flavouring | g | — | — | — | — | — | 6.00 | — |
| Citric acid | g | — | 2.60 | — | — | — | — | — |
| Calcium chloride dihydrate | g | 7.62 | — | — | — | 7.89 | — | — |

1. A process for preparing from one or more ingredients a plurality of dairy food gel products having a range of predetermined organoleptic properties, wherein at least one ingredient is a milk protein concentrate (MPC) or dairy food gel ingredient comprising an MPC, wherein the MPC is selected from a fermented MPC (fMPC), calcium reduced MPC (cMPC), and a fermented calcium reduced MPC (fcMPC), and wherein the process comprises the steps of:
selecting process conditions for at least one of the plurality of dairy food gel products having predetermined organoleptic properties, wherein the process conditions comprise predetermined parameters selected from liquid content, process temperature, and process duration;
processing the ingredients according to the selected process conditions; and
obtaining at least one of the plurality of dairy food products having predetermined organoleptic properties based on the selected process conditions.

2. A process of modulating texture of a mixture of one or more ingredients, wherein at least one ingredient is a milk protein concentrate (MPC) or dairy food gel ingredient comprising an MPC, wherein the MPC is selected from a fermented MPC (fMPC), calcium reduced MPC (cMPC), and a fermented calcium reduced MPC (fcMPC), and wherein the method comprises the steps of:
selecting process conditions comprising predetermined parameters selected from liquid content, process temperature, and process duration;
processing the ingredients according to the selected process conditions to form a dairy food gel product having predetermined texture based on the selected process conditions; and
obtaining the dairy food gel product.

3. The process of claim 1 or claim 2, wherein the process conditions consist of predetermined parameters selected from liquid content, process temperature, process duration, and optionally process mixing.

4. The process of any one of claims 1 to 3, wherein the one or more ingredients are selected from solids or dry mixtures, and the selecting of the process conditions for liquid content is an addition of water to the one or more ingredients.

5. The process of any one of claims 1 to 4, wherein the process temperature is between about 55 and 400° C.

6. The process of any one of claims 1 to 5, wherein the process duration is less than about 60 minutes.

7. The process of any one of claims 1 to 6, wherein the process conditions comprise shear process mixing.

8. The process of any one of claims 1 to 7, wherein all dairy protein provided in the process by any of the one or more ingredients consists of, or consists essentially of, an MPC, for example a fMPC, cMPC, fcMPC, or any combination thereof.

9. The process of any one of claims 1 to 8, wherein the one or more ingredients further comprise or consist of one or more MPC, one or more dairy food gel ingredient(s) comprising an MPC, and optionally one or more additive ingredients.

10. The process of any one of claims 1 to 9, wherein the one or more ingredients further comprise or consist of one or more cMPC, one or more dairy food gel ingredient(s) comprising an cMPC, and optionally one or more additive ingredients.

11. The process of any one of claims 1 to 10, wherein any additive ingredients, if present, are selected from the group consisting of antioxidant, artificial sweeteners, carbohydrate, emulsifiers, fats, acids, colourants, dietary supplements, humectants, enzymes, flavourings, flavour enhancers, foaming agents, herbs, mineral salts, prebiotics, probiotics, postbiotics, preservatives, protein, thickeners and vegetable gums, spices, stabilisers and firming agents, sweeteners, vitamins, glazing agents, gelling agents, propellants, raising agents, bulking agents.

12. The process of any one of claims 1 to 11, wherein the dairy food gel ingredient comprises one or more additive ingredients selected from a fat additive ingredient, a mineral salt additive ingredient, and a food acid additive ingredient.

13. The process of any one of claims 1 to 12, wherein the dairy food gel ingredient comprises one or more additive ingredients selected from flavourings, colourants, sweeteners, emulsifiers, stabilisers, and thickeners.

14. The process of any one of claims 1 to 13, wherein the dairy food gel ingredient comprises one or more additive ingredients selected from proteins, prebiotics, probiotics, and postbiotics.

15. The process of any one of claims 1 to 14, wherein the one or more ingredients further comprise or consist of one or more MPC and/or one or more dairy food gel ingredient(s) comprising an MPC.

16. The process of any one of claims 1 to 15, wherein the MPC is a cMPC.

17. The process of any one of claims 1 to 16, wherein the MPC is a fcMPC.

18. The process of any one of claims 1 to 17, wherein the MPC comprises:
a fat content of between 0 to about 60% w/w;
a calcium content of between about 20 to about 400 mmol/kg; and
a cationic balance of between about 1 to about 100.

19. The process of any one of claims 1 to 18, wherein the fat content of the MPC is between about 40 to about 70% w/w.

20. The process of any one of claims 1 to 19, wherein the calcium content of the MPC is between about 20 to about 100 mmol/kg.

21. The process of any one of claims 1 to 20, wherein the cationic balance of the MPC is between 10 to 60.

22. The process of any one of claims 1 to 21, wherein a monovalent to divalent cation ratio of the MPC is between about 5 to 30.

23. The process of any one of claims 1 to 22, wherein the protein content of the MPC is between about 20 to 95% w/w.

24. The process of any one of claims 1 to 23, wherein the calcium to protein ratio (in g/kg) of the MPC is between about 0.1 to 15.

25. The process of any one of claims 1 to 24, wherein the MPC is a fcMPC, and wherein the fcMPC is prepared comprising steps of:
subjecting concentrated milk, reconstituted dry milk concentrate or an aqueous solution comprising an MPC to a divalent ion reduction or exchange step to obtain a divalent ion reduced retentate;
subjecting the retentate to fermentation to produce a fermentate;
concentrating the fermentate to produce an MPC ingredient; and
recovering the fcMPC ingredient.

26. The process of claim 25, wherein the method further comprises subjecting the fermentate to an enzymatic modification.

27. The process of claim 26, wherein the enzymatic modification is κ-casein cleavage.

28. A dairy food gel product prepared according to the process of any one of claims 1 to 27.

29. A fermented and calcium depleted milk protein concentrate (fcMPC) ingredient, wherein the fcMPC comprises:
a fat content of between 0 to about 60% w/w;
a calcium content of between about 20 to about 400 mmol/kg; and
a cationic balance of between about 1 to about 100.

30. The fcMPC ingredient of claim 29, wherein the fat content is between about 40 to about 70% w/w.

31. The fcMPC ingredient of claim 29 or claim 30, wherein the calcium content is between about 20 to about 100 mmol/kg.

32. The fcMPC ingredient of any one of claims 29 to 31, wherein the cationic balance is between 10 to 60.

33. The fcMPC ingredient of any one of claims 29 to 32, further comprising a monovalent to divalent cation ratio of between about 5 to 30.

34. The fcMPC ingredient of any one of claims 29 to 33, further comprising a protein content of between about 20 to 95% w/w.

35. The fcMPC ingredient of any one of claims 29 to 34, further comprising a calcium to protein ratio (in g/kg) between about 0.1 and about 15.

36. A dairy food gel ingredient comprising the fcMPC ingredient of any one of claims 29 to 35 and one or more additive ingredients.

37. The dairy food gel ingredient of claim 36, wherein the one or more additive ingredients comprise any one or more ingredients selected from a fat additive ingredient, a mineral salt additive ingredient, and a food acid additive ingredient.

38. The dairy food gel ingredient of claim 36 or claim 37, wherein the one or more additive ingredients comprise any one or more ingredients selected from flavourings, colourants, sweeteners, emulsifiers, stabilisers, and thickeners.

39. The dairy food gel ingredient of any one of claims 36 to 38, wherein the one or more additive ingredients comprise any one or more ingredients selected from proteins, prebiotics, probiotics, and postbiotics.

40. The dairy food gel ingredient of any one of claims 36 to 39, wherein any additive ingredients, if present, do not include any dairy proteins.

41. The dairy food gel ingredient of any one of claims 36 to 40, wherein any additive ingredients, if present, do not include any natural cheese.

42. The dairy food gel ingredient of any one of claims 36 to 41, wherein the MPC, one or more additives, or dairy food gel ingredient, is a powder or in the form of a dry mixture.

43. A food processing system configured to be used in the process of any one of claims 1 to 27, the food processing system comprising:
a food processor base configured for receiving the one or more ingredients and liquid,
a heating system configured for heating any of the one or more ingredients and liquid,
optionally a mixing system for mixing any of the one or more ingredients and liquid, and
a system controller configured for receiving a user input for selection of a dairy food gel product having predetermined organoleptic properties, wherein the system controller selects predetermined process conditions for the selected dairy food gel product having predetermined organoleptic properties, and the process conditions comprise predetermined parameters selected from liquid content, process temperature, and process duration, and optional mixing, to obtain the selected dairy food product from the plurality of dairy food gel products having a range of predetermined organoleptic properties.
